(19) United States
(12) Patent Application Publication
(10) Pub. No.: US 2009/0134734 A1
(43) Pub. Date: May 28, 2009

(54) Ac motor and control unit thereof

(75) Inventor: Masayuki Nashiki, Komaki-shi (JP)

Correspondence Address: OLIFF & BERRIDGE, PLC, P.O. BOX 320850, ALEXANDRIA, VA, 22320-4850, US

(73) Assignee: DENSO CORPORATION, KARIYA-CITY (JP)

(21) Appl. No.: 11/988,935

(22) PCT Filed: Jul. 19, 2006
(86) PCT No.: PCT/JP2006/314256

§ 371 Date: Feb. 8, 2008

(30) Foreign Application Priority Data
Jul. 19, 2005 (JP) 2005-208358

(51) Int. Cl. H02K 19/10; H02P 6/14; H02K 1/12

(52) U.S. Cl. 310/162; 318/400.13; 310/254; 318/400.27

(57) ABSTRACT

The motor, which is an incorporated N-phased motor, comprises a rotor having four or more poles with N-poles and S-poles being alternately arranged in the circumferential direction, a stator having a stator core in which magnetic circuits are magnetically separated within an electrical angle of 360°, and an (N−1) number (N is a positive integer) of windings. The motor is configured so that currents of the windings can effectively work on the magnetic circuits.

### TECHNICAL FIELD OF THE INVENTION

The present invention relates to a motor which is loaded, for example, on an automobile or a truck.

### TECHNICAL BACKGROUND

Brushless motors have been known, in which coils of individual phases are concentrically wound about the stator poles (see, for example, Patent Document 1). FIG. 95 is a schematic vertical cross section illustrating such a conventional brushless motor. FIG. 97 is a cross section taking along a line AA-AA of FIG. 95.

These figures show a four-pole six-slot type brushless motor having a stator with a so-called concentrated winding structure, in which coils of individual phases are concentrically wound about the stator poles. FIG. 96 is a circumferential development of one cycle of the stator, which indicates an arrangement relationship of windings U, V and W or the like. The horizontal axis indicates electrical angle, with one cycle being 720°. Permanent magnets of N- and S-poles are alternately arranged in the circumferential direction on the surface of a rotor 2. In a stator 4, U-phase stator poles TBU1 and TBU2 are imparted with turns of U-phase windings WBU1 and WBU2, respectively. Similarly, V-phase stator poles TBV1 and TBV2 are imparted with turns of V-phase windings WBV1 and WBV2, respectively. W-phase stator poles TBW1 and TBW2 are imparted with turns of W-phase windings WBW1 and WBW2, respectively. Brushless motors having such a structure are widely utilized currently for industrial and household uses.

FIG. 98 is a transverse cross section of another stator. The stator shown in FIG. 98 has a 24-slot configuration which enables distributed winding in case of a four-pole motor. This type of stator can make a comparatively smooth sinusoidal magnetomotive force distribution in the stator along the circumference thereof, and thus has been widely used, for example, in brushless motors, winding field type synchronous motors and induction motors. Accurate rotating field is particularly desired to be produced by the stator in the cases, for example, of synchronous reluctance motors utilizing reluctance torque and various types of motors in which reluctance torque is applied, or induction motors. For these motors, a stator structure of full-pitch or distributed winding as shown in FIG. 98 is appropriate. The rotor shown in FIG. 98 is a multi-flux barrier rotor of a reluctance motor. The rotor is provided therein with a plurality of slit-like spaces between the rotor poles so as to be substantially parallel to each other. These slit-like spaces create a difference in magnetic resistance according to the orientation of the rotor to thereby produce polarities in the rotor.

[Patent Document 1] Japanese Patent Laid-Open No. 6-261513 (page 3 and FIGS. 1 to 3)

### DISCLOSURE OF THE INVENTION

### Problems to be Solved by the Invention

The stator structure enabling full-pitch or distributed winding as shown in FIG. 98 can make a comparatively smooth sinusoidal magnetomotive force distribution in the stator. Thus, such a stator structure has a characteristic that it can effectively drive an induction motor, or synchronous reluctance motor having a multi-flux barrier rotor as shown in FIG. 98. However, this structure has raised a problem of difficulty in reducing the motor size because, due to the necessity of inserting a winding from an opening of a slot, the space factor of the windings is lowered and thus the axial length of the coil end becomes large. This structure has also raised a problem of low productivity of the windings.

The brushless motor shown in FIGS. 95, 96 and 97 and the conventional brushless motor disclosed in Patent Document 1 have a structure in which turns of the windings are provided to the respective teeth. Therefore, the windings are comparatively simple and the axial length of each coil end is comparatively small, with the productivity of the windings being more improved than the motor shown in FIG. 98. However, since these motors are structured to have only three salient stator poles within a range of 360° in electrical angle, there has been a problem of difficulty in forming the magnetomotive force generated by the stator into a sinusoidal shape to produce an accurate rotating field, leading to a difficulty in applying such a stator to synchronous reluctance motors and various types of motors in which reluctance torque is applied, or induction motors. Although the stator shown in FIG. 97 is comparatively simply structured, it is desired that the windings be further simplified, the space factor of the windings be further improved, and the coil end be further shortened.

Problems regarding rotors include a problem that, in a multi-flux barrier rotor as shown in FIG. 98, the load imposed by d-axis currents serving as excitation currents for producing magnetic fields is so large that the power factor is lowered and thus the motor efficiency is deteriorated, comparing with a permanent magnet rotor as shown in FIG. 97. Permanent magnet rotors, meanwhile, have suffered from a problem in the cost of the permanent magnets.

The current motor technique is based on the premise that motors have a structure in which electromagnetic steel plates are stacked in the rotor shaft direction. Thus, a problem of soft magnetic materials used for such motors is that, if magnetic fluxes are permitted to increase/decrease in three-dimensional directions including the rotor shaft direction in order to solve the motor problems provided above, large eddy currents are induced in the electromagnetic steel plates to cause large eddy current loss.

In case of a motor having a small capacity, in particular, there is a problem that the large number of power elements of the control unit of the motor makes the motor expensive comparing with the case of driving a DC motor.

The present invention has been made in light of such problems and has as its objects to realize a small stator configuration of high performance, a rotor for achieving high efficiency at low cost, a soft magnetic material configuration for enabling such a motor configuration, and a control unit for the motor at low cost, and to realize a more advantageous structure and performance by combining the foregoing components.

### Means for Solving Problems

For the conventional cylindrical stator configuration made of a soft magnetic material, magnetic fluxes interlinking with specific windings can be increased by magnetically separating the soft magnetic stator in the circumferential direction. As a result, the specific windings can more effectively generate torque than the conventional windings, that is, such windings can generate torque with high efficiency. At the same time, other windings are partially adapted not to be effected by the magnetic fluxes, and thus, such windings can be removed. By combining such advantages, high efficiency and size reduction can be achieved in a single motor, two-phase motor, three-phase motor and multiphase motor of four or more phases.

In a six-phase motor, the magnetic circuits of the individual phases of the stator may be divided to pass three-phase currents IA, IB and IC therethrough, which currents are in a relationship expressed by IA+IB+IC=0, i.e. IC=−IA−IB. Thus, the current IC may be served by the currents IA and IB to remove the winding IC. As a result, high efficiency and size reduction can be achieved.

The motor mentioned above, in which the soft magnetic stator is magnetically separated in the circumferential direction, can be converted, in an electromagnetically equivalent manner, into a motor having loop windings in the circumferential direction of the stator. In this case, since each of the windings of the individual phases is not required to reciprocate in the rotor shaft direction passing through the soft magnetic portion of the stator, an advantage of further simplifying the windings can be achieved. Thus, high efficiency can be achieved by the motor. As a specific configuration, a motor can be configured by loop windings of two among three phases, and three-set six-phase stator poles.

A stator may have a configuration, which includes slots SL1, SL2, SL3, SL4, SL5 and SL6 arranged along the circumference, and three-phase windings including U-phase windings UU1 and UU2, V-phase windings VV1 and VV2 and W-phase windings WW1 and WW2. In this stator configuration, the U-phase winding UU1 is wound between the slots SL1 and SL3, the V-phase winding VV1 is wound between the slots SL3 and SL5, and the W-phase winding WW1 is wound between the slots SL5 and SL1. These windings UW1, VV1 and WW1 constitute a first winding group. Further, the U-phase winding UU2 is wound between the slots SL6 and SL4, the V-phase winding VV2 is wound between the slots SL4 and SL2, and the W-phase winding WW2 is wound between the slots SL2 and SL6. These windings UU2, VV2 and WW2 constitute a second group. Thus, winding intersections of the individual phases at coil end portions can be simplified, with the axial length of the coil ends being reduced. In addition, the magnetomotive force of the stator poles can be permitted to have six phases. Thus, motors, such as a synchronous reluctance motor of multi-flux barrier type, can be driven with small torque ripple.

In a configuration of a synchronous reluctance motor using a multi-flux barrier rotor, a rotor poles may be imparted with turns of a closed-circuit windings with a diode being connected in series. Field energy may be supplied to this winding by a stator-side winding current to have a field current held via the diode, thereby producing field magnetic flux.

In a controllable manner, the field energy may be adapted to be supplied as needed to improve the average motor power factor and efficiency. The field current may be covered by the stator side current and the rotor side current so that copper loss may also be further reduced throughout the motor.

On the other hand, in addition to the problem concerning the power factor and the copper loss, synchronous reluctance motors have a problem that the space factor of stator windings is low and the length of the coil ends is large. Combination with the stators provided below will solve these problems and may allow the motor of the present invention to obtain a competitive force.

A specific example of such a stator may include substantially looped stator windings which are arranged between the stator poles of the individual phases so as to go around the circumference of the stator. Generally, the larger the number of poles is, the more the advantages can be obtained. Two to six or more multiple phases may be available in terms of the phases of the stator poles. The stator may have an arrangement in which the stator poles are arranged in the order of their phases, or in which the stator poles are arranged so that stator poles of a certain phase may have a phase difference of about 180° in electrical angle from the adjacent stator poles. Each of these manners of arrangement has advantages and disadvantages.

Another specific example of a stator may include slots SL1, SL2, SL3, SL4, SL5 and SL6 arranged along the circumference, and three-phase windings including U-phase windings UU1 and UU2, V-phase windings VV1 and VV2 and W-phase windings WW1 and WW2. In the stator configuration, the U-phase winding UU1 is wound between the slots SL1 and SL3, the V-phase winding VV1 is wound between the slots SL3 and SL5, and the W-phase winding WW1 is wound between the slots SL5 and SL1. These windings UW1, VV1 and WW1 constitute a first winding group. Further, the U-phase winding UU2 is wound between the slots SL6 and SL4, the V-phase winding VV2 is wound between the slots SL4 and SL2, and the W-phase winding WW2 is wound between the slots SL2 and SL6. These windings UU2, VV2 and WW2 constitute a second group.

Additional provision of permanent magnets to the above various types of motor may effectively enhance performance, while suppressing the increase of cost as much as possible.

A configuration may be such that each soft magnetic portion of an inset rotor is imparted with turns of closed-circuit windings with a diode being connected in series, the turns being imparted at positions where the soft magnetic portions can be excited.

In a flux barrier rotor, instead of stacking the electromagnetic steel plates along the rotor shaft, electromagnetic steel plates, each being molded into an arc form, may be arranged parallel to the rotor shaft, that is, may be radially stacked to obtain a so-called axially stacked rotor. In particular, the stator having the loop windings and allowing magnetic fluxes to increase/decrease while the magnetic fluxes pass in the rotor shaft direction, may have a problem of eddy currents at the soft magnetic portions. Meanwhile, the axially stacked rotor may facilitate the movement of the magnetic fluxes in the rotor shaft direction and is electromagnetically compatible with the stator having the loop windings. Further, in the vicinity of a rotor surface of the axially stacked rotor, it may be effective to provide an electrical insulation treatment in the direction perpendicular to the rotor shaft direction so as to prevent eddy currents from being caused.

When magnetic fluxes in the rotor shaft direction are generated in the soft magnetic material and increased/decreased, the eddy current in the soft magnetic material will become problematic. To cope with this, it is preferred to use electromagnetic steel plates provided therein with electrically insulating films.

Combination of the techniques mentioned above may achieve a significantly competitive configuration as a motor with reduced size and high performance or the like. A configuration of a specific combination, for example, may include a stator having loop windings, an axial gap rotor, field windings and diodes of the rotor, and electromagnetic steel plates having insulating films, whose magnetic fluxes can be directed to any directions.

The excitation currents in the fields can be controlled more effectively by using the configuration in which magnetic poles of the rotor are imparted with turns of windings having a serially connected diode. Specifically, d-axis currents may be passed from the windings of the stator to supply field energy. The idea is that currents passing through secondary windings are to hold the field energy even after the stator-side d-axis currents have been eliminated, which is an operation of an electromagnetic circuit. Alternatively, control may be effected in such a way that the stator-side d-axis currents and the rotor-side winding currents are brought into harmonization to totally reduce copper loss associated with the field currents.

Control may also be effected by providing a configuration in which the control unit for driving the motor mentioned above have three output terminals derived from two power sources and four power elements, for interconnection with three input terminals derived from internal connection in the two-, three- or four-phase motor. In the above two power sources, one power source may be made up of a DC-DC converter.

In a four-phase AC motor with three windings, control may be effected by star-connecting the windings to obtain a total of four terminals with three terminals of the star connection and a center point of the star connection, and by establishing connection with a four-phase AC inverter.

### BRIEF DESCRIPTION OF THE DRAWINGS

FIG. 1 is a schematic transverse cross section illustrating a conventional single-phase four-pole motor;

FIG. 2 illustrates a modification of the motor illustrated in FIG. 1, with the stator being partially cut out;

FIG. 3 is a schematic transverse cross section illustrating a single-phase eight-pole motor, in which the stator core is magnetically segmented at every 360° in electrical angle;

FIG. 4 is a schematic transverse cross section illustrating a three-phase eight-pole motor, in which the stator core is magnetically segmented at every 360° in electrical angle;

FIG. 5 is a schematic transverse cross section illustrating a single-phase eight-pole motor, in which the stator core is magnetically segmented at every 360° in electrical angle;

FIG. 6 is a schematic transverse cross section illustrating a single-phase twelve-pole motor, in which the stator core is magnetically segmented at every 360° in electrical angle;

FIG. 7 is a schematic transverse cross section illustrating a single-phase eight-pole motor, in which the stator core is magnetically segmented at every 360° in electrical angle;

FIG. 8 illustrates cross sections of the motor illustrated in FIG. 7;

FIG. 9 is a schematic transverse cross section illustrating a three-phase eight-pole motor, in which the stator core is magnetically segmented at every 360° in electrical angle;

FIG. 10 is a schematic transverse cross section illustrating a single-phase eight-pole motor, in which the stator core is magnetically segmented at every 360° in electrical angle;

FIG. 11 illustrates cross sections of the motor illustrated in FIG. 10;

FIG. 12 is a transverse cross section illustrating a conventional three-phase two-pole motor;

FIG. 13 illustrates a modification of the motor illustrated in FIG. 12, with the stator being partially cut out;

FIG. 14 illustrates a modification of the motor illustrated in FIG. 13, the modification being made in the windings;

FIG. 15 illustrates vectors of winding currents shown in FIGS. 12 and 13;

FIG. 16 is a schematic transverse cross section illustrating a three-phase four-pole motor, in which the stator core is magnetically segmented at every 360° in electrical angle;

FIG. 17 illustrates cross sections of the motor illustrated in FIG. 16;

FIG. 18 is a perspective view of the stator core of the motor illustrated in FIG. 16;

FIG. 19 illustrates schematic transverse and vertical cross sections of an incorporated three-phase eight-pole motor, in which the stator core is magnetically segmented at every 360° in electrical angle;

FIG. 20 is a schematic cross section illustrating a conventional four-phase two-pole motor;

FIG. 21 is a schematic cross section illustrating a conventional four-phase two-pole motor;

FIG. 22 illustrates a modification of the motor illustrated in FIG. 21, with the stator being partially cut out;

FIG. 23 illustrates current vectors of the windings illustrated in FIGS. 20, 21 and 22;

FIG. 24 is a schematic transverse cross section illustrating a four-phase eight-pole motor, in which the stator core is magnetically segmented at every 360° in electrical angle;

FIG. 25 is a schematic transverse cross section illustrating a four-phase eight-pole motor, in which the stator core is magnetically segmented at every 360° in electrical angle;

FIG. 26 illustrates schematic transverse and vertical cross sections of an incorporated four-phase eight-pole motor, in which the stator core is segmented at every 360° in electrical angle;

FIG. 27 is a schematic transverse cross section of a conventional six-phase two-pole motor;

FIG. 28 illustrates a modification of the motor illustrated in FIG. 27, with the stator being partially cut out;

FIG. 29 is a pattern diagram illustrating a six-phase motor structure, in which a magnetic circuit of the stator is magnetically separated into three;

FIG. 30 illustrates an example of a modification of the pattern diagram of the motor illustrated in FIG. 29;

FIG. 31 illustrates an example of a modification of the pattern diagram of the motor illustrated in FIG. 29;

FIG. 32 illustrates current vectors of the windings illustrated in FIGS. 27 to 31;

FIG. 33 is a pattern diagram illustrating a six-phase motor in which a magnetic circuit of the stator is magnetically separated into three so as to be constituted with two windings;

FIG. 34 is a schematic vertical cross section illustrating a three-phase eight-pole motor having loop windings;

FIG. 35 is a development illustrating a rotor surface of the motor illustrated in FIG. 34;

FIG. 36 illustrates cross sections of the motor illustrated in FIG. 34;

FIG. 37 is a development illustrating a surface configuration of the stator poles illustrated in FIG. 34, which is opposed to the rotor;

FIG. 38 illustrates a shape of the winding of the motor illustrated in FIG. 34;

FIG. 39 is a development illustrating the windings of the motor illustrated in FIG. 34;

FIG. 40 is a development illustrating the windings of the motor illustrated in FIG. 34 as combined into two;

FIG. 41 is a development illustrating a relationship between the stator poles and windings of the motor illustrated in FIG. 34;

FIG. 42 illustrates vectors of currents, voltages and torque of the motor illustrated in FIG. 34;

FIG. 43 is a development illustrating an example of a configuration of the stator poles shown in FIG. 34, which is opposed to the rotor;

FIG. 44 is a development illustrating an example of a configuration of the stator poles shown in FIG. 34, which is opposed to the rotor;

FIG. 45 is a development illustrating an example of a configuration of the stator poles shown in FIG. 34, which is opposed to the rotor;

FIG. 46 is a transverse cross section illustrating an example of an embedded magnet rotor;

FIG. 47 is a transverse cross section illustrating an example of an embedded magnet rotor;

FIG. 48 is a transverse cross section illustrating an example of an inset rotor;

FIG. 49 is a transverse cross section illustrating an example of a reluctance rotor having salient poles;

FIG. 50 illustrates vectors of two to seven phases;

FIG. 51 illustrates relationships between six-phase vectors and composite vectors thereof;

FIG. 52 is a development of a four-phase motor having loop windings, in which stator poles and the windings are arranged so as to have a phase difference of 180° in electrical angle between adjacent stator poles;

FIG. 53 illustrates a relationship between four-phase vectors and compositions thereof;

FIG. 54 is a development illustrating stator poles and windings, obtained by improving those of the motor having a configuration illustrated in FIG. 52;

FIG. 55 is a cross section illustrating the motor illustrated in FIG. 54;

FIG. 56 is a schematic vertical cross section illustrating a six-phase motor having loop windings;

FIG. 57 is a schematic vertical cross section illustrating a six-phase motor having loop windings, in which the stator core is magnetically separated into three;

FIG. 58 is a schematic vertical cross section illustrating a motor obtained by reducing the windings of the motor illustrated in FIG. 57 to two;

FIG. 59 illustrates an example of a modification of the motor illustrated in FIG. 58;

FIG. 60 is a development of the motor illustrated in FIG. 59, illustrating a surface configuration of the rotor, a surface configuration of the stator poles opposed to the rotor, and the windings;

FIG. 61 is a development in which the stator poles illustrated in FIG. 60 are circumferentially skewed;

FIG. 62 is a development illustrating a relationship between the surface configuration of the stator poles opposed to the rotor and magnetic circuits to be connected thereto in the motor illustrated in FIG. 59;

FIG. 63 is a development illustrating an example of electromagnetic steel plates constituting the stator poles illustrated in FIG. 62;

FIG. 64 is illustrates an arrangement of the stator poles of the motor illustrated in FIG. 59 and electrically conductive plates for reducing mutual flux leakage from between the stator poles;

FIG. 65 illustrates a connecting relationship of stator windings in a conventional three-phase two-pole motor;

FIG. 66 illustrates a connecting relationship of windings in a three-phase two-pole motor with double arrangement of short-pitch winding;

FIG. 67 is a vertical cross section of the motor illustrated in FIG. 66, illustrating coil end shapes and an arrangement of the windings;

FIG. 68 is a vector diagram illustrating current vectors of the windings illustrated in FIG. 66 and composed current vectors in the slots;

FIG. 69 is a transverse cross section illustrating a four-pole rotor constituting closed circuits, in which windings having a serially connected diode are wound about conventional rotor poles of soft magnetic material, each having a salient shape;

FIG. 70 is a transverse cross section illustrating a four-pole rotor provided with a plurality of magnetic flux barriers, and constituting closed circuits, in which windings having a serially connected diode are wound about;

FIG. 71 illustrates a connecting relationship between the windings and a diode of the rotor illustrated in FIGS. 69 and 70;

FIG. 72 schematically illustrates a two-pole rotor, which is a modification of the rotor illustrated in FIG. 70, including d-axis current “id” and q-axis current “iq” of the stator windings;

FIG. 73 illustrates a relationship between the current components and voltages of FIG. 72, and illustrates an equivalent model of a d-axis magnetic circuit;

FIG. 74 illustrates d-axis current “id” and q-axis current “iq” for outputting constant torque;

FIG. 75 illustrates a waveform example of intermittent d-axis current “id” of a stator and current “ifr” of a rotor winding;

FIG. 76 illustrates a waveform example at the time of performing control in a state where intermittent d-axis current “id” of a stator winding coexists with current “ifr” of a rotor winding;

FIG. 77 is a transverse cross section illustrating a rotor, which is a modification of the rotor illustrated in FIG. 70, including permanent magnets;

FIG. 78 is a transverse cross section of an eight-pole inset rotor constituting closed circuits, in which windings having a serially connected diode are wound about;

FIG. 79 is a transverse cross section of an eight-pole multi-flux barrier rotor including radially stacked electromagnetic steel plates and constituting closed circuits, in which windings having a serially connected diode are wound about;

FIG. 80 illustrates perspective views of examples of the electromagnetic steel plates used for the rotor illustrated in FIG. 79;

FIG. 81 illustrates configurations of electromagnetic steel plates including electrically insulating films therein;

FIG. 82 illustrates an example of use of the electromagnetic steel plates having the insulating films illustrated in FIG. 81, by stacking the plates crisscross;

FIG. 83 illustrates a relationship between a three-phase inverter configuration and three-phase motor windings;

FIG. 84 illustrates a connecting relationship between a three-phase inverter and the three-phase motor with two windings illustrated in FIG. 34;

FIG. 85 illustrates a vectorial relationship between the voltages and currents of FIG. 84;

FIG. 86 illustrates a relationship between the windings, currents and voltages of FIG. 84;

FIG. 87 illustrates a configuration for controlling the three-phase motor with two windings illustrated in FIG. 34 by an inverter having four power control elements;

FIG. 88 illustrates a configuration for controlling a three-phase motor of delta connection by an inverter having four power control elements;

FIG. 89 illustrates vectorial relationships of the voltages of FIGS. 89 and 90;

FIG. 90 illustrates voltage waveforms of FIG. 87;

FIG. 91 illustrates voltage waveforms of FIG. 88;

FIG. 92 illustrates a configuration for controlling a three-phase motor of star connection by an inverter having four power control elements;

FIG. 93 illustrates an example in which one of DC power sources of FIGS. 87, 88 and 92 is made up of a DC-DC converter;

FIG. 94 illustrates an example in which one of DC power sources of FIGS. 87, 88 and 92 is made up of a DC-DC converter;

FIG. 95 is a schematic vertical cross section illustrating a conventional brushless motor;

FIG. 96 is a cross section taken along a line AA-AA of FIG. 95;

FIG. 97 is a transverse cross section illustrating a conventional brushless motor; and

FIG. 98 is a transverse cross section illustrating a conventional synchronous reluctance motor.

### DESCRIPTION OF SYMBOLS

B21: Inner-diameter side rotor
B2D: Outer-diameter side rotor
B23, B25 and B27: Inner-diameter side stator poles
B24, B26 and B28: Outer-diameter side stator poles
B29 and B2A: windings of phase “a”
B2B and B2C: windings of phase “b”

### BEST MODES FOR IMPLEMENTING THE INVENTION

With reference to the drawings, hereinafter will be described, in detail, motors according to various embodiments to which the present invention is applied.

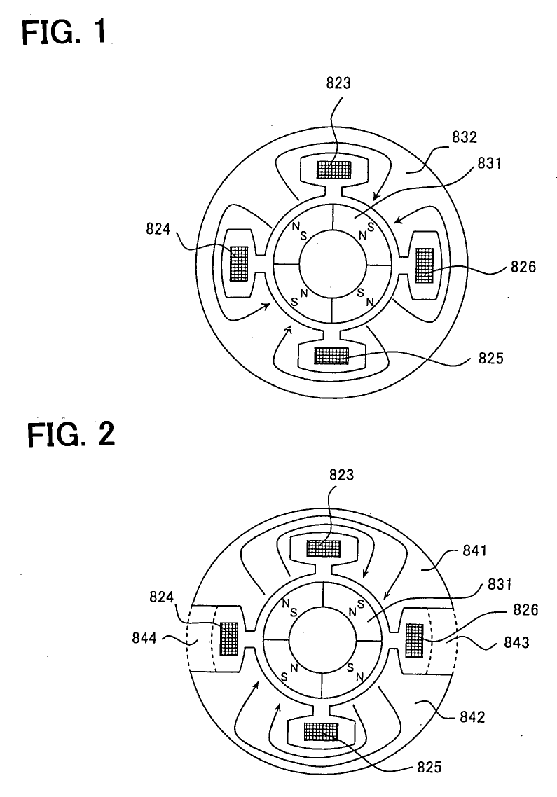

FIG. 1 shows a single-phase four-pole AC motor. Indicated by numeral 831 are permanent magnets for a rotor, by 832 is a stator core made of soft magnetic material, and by 823, 824, 825 and 826 are single-phase windings. Some methods may be provided in giving turns of the windings. One example is to give turns of the windings 823 and 824 to obtain single-phase windings, and to give turns of the windings 825 and 826 to obtain single-phase windings. In this case, the maximum amount of magnetic fluxes interlinking with the winding 823 shown in FIG. 1 corresponds to ½ of magnetic fluxes of one magnetic pole of the permanent magnet 831.

FIG. 2 shows a motor of FIG. 1 but with portions 843 and 844 shown by broken lines being cut and removed. In this case, the maximum amount of magnetic fluxes interlinking with the winding 823 shown in FIG. 2 corresponds to magnetic fluxes of one magnetic pole of the permanent magnets 831. Accordingly, the winding 823 of FIG. 2 can generate torque twice as large as that of the winding 823 of FIG. 1. In this case, however, magnetic fluxes interlinking with the windings 824 and 826 of FIG. 2 are zeroed, making no contribution to torque generation. Thus, the windings 824 and 826 are unnecessary for a motor in terms of electromagnetic torque generation and thus can be removed. However, since the windings 823 and 824 are a pair of windings through which reciprocal currents are passed in the rotor shaft direction, the winding 824 cannot be removed. Therefore, the winding 824 may be shortened or may be advantageously utilized in other application.

Such an advantage can particularly be realized in an AC motor constituted with a permanent magnet rotor. This is because a permanent magnet synchronous motor, whose fields are produced by the permanent magnets, requires only q-axis currents, or vector currents, to be passed to the stator-side windings, and thus the motor can be simplified owing to the unnecessity of having a configuration of conventional classical full-pitch winding or distributed winding.

In the motor shown in FIG. 2, since the maximum magnetic fluxes passing through diameter-side back yoke portions of the windings 823 and 825 are larger by a factor of two, the back yoke portions are required to be designed with a thickness which is larger by a factor of two. However, use of a multipolarized motor may reduce the thickness of the soft magnetic material in the back yoke portions. Thus, multipolarization can reduce the loading on the back yoke portions.

As will be described later, a multiphase AC motor can be realized by utilizing the effects and advantages of the magnetic circuits as mentioned above, which increase the number of interlinked magnetic fluxes.

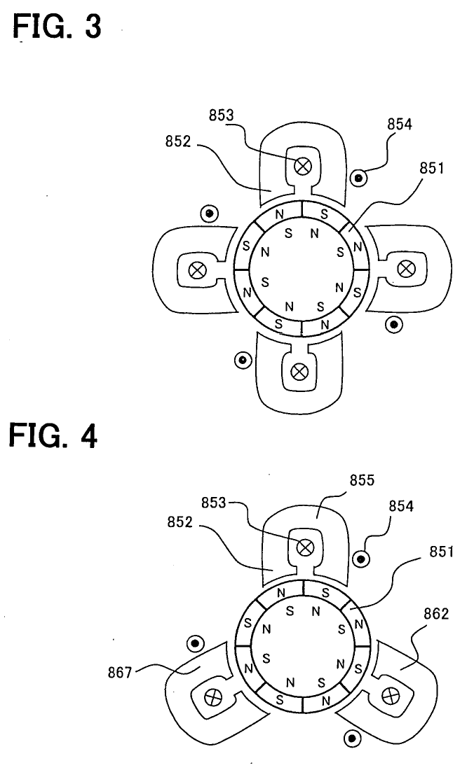

FIG. 3 shows an eight-pole version of the single-phase AC motor shown in FIG. 2. Indicated by numeral 852 is a magnetic pole and magnetic path of the stator, by 853 and 854 are windings for imparting the stator pole 852 with magnetomotive force, and by 851 are permanent magnets for the rotor. Each of the windings 854, which is arranged in a space through an interlinked closed magnetic circuit space, has very large magnetic resistance, and thus the magnetomotive force generated by the current of the winding hardly influences the electromagnetic effect of the motor. Accordingly, since there is only an effect of the windings 853 as return wires for current, the turns of each of the windings 853 may be given in a space of the motor, at a position that can allow a coil end thereof to be as short as possible.

FIG. 4 shows a three-phase AC motor, which, for the motor shown in FIG. 3, is configured to have one less set of stator poles and windings, and to have a relative phase difference of 120° in electrical angle between three stator poles 852, 867 and 862. Similar to FIG. 3, the windings 853 and 854 reciprocating in the rotor shaft direction are brought closer to each other so as to be compact.

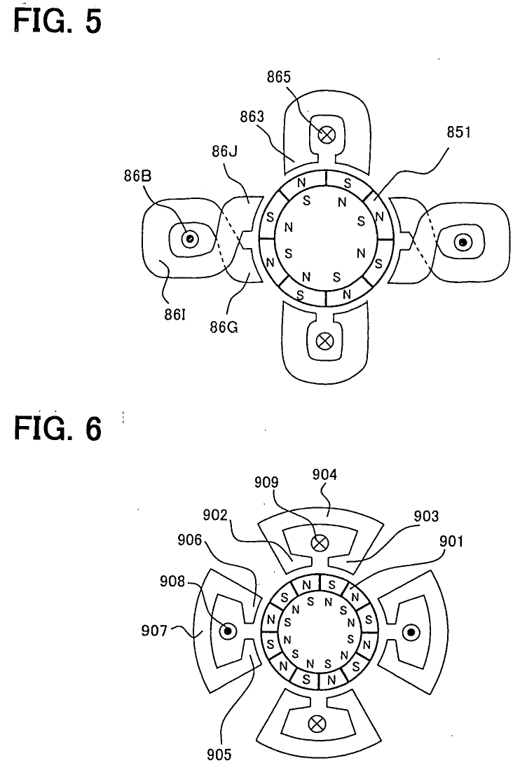

FIG. 5 shows a single-phase AC motor, in which directions of stator poles 86G and 863 and a magnetic circuit 861 are differentiated by 180° so as to provide a reversed configuration. Thus, currents of a winding 865 and a winding 86B can be oppositely directed to have both of the windings served as a pair of windings. As a result, the winding 854 as a return wire shown in FIG. 3 can be removed. Comparing with the motor shown in FIG. 3, windings can be reduced. Thus, in addition to the reduction in the amount of the winding, copper loss of the motor in its entirety can be reduced.

FIG. 6 shows a single-phase twelve-pole AC motor. For stator poles 902 and 903, stator poles 905 and 906 are arranged so as to have a phase difference of 180° in electrical angle from the rotor. As a result, by passing reverse currents through windings 909 and 908, these windings will serve as windings reciprocating in the rotor shaft direction. In this case as well, the windings 854 required for the motor shown in FIG. 3 can be eliminated. Thus, the amount of winding can be reduced to also reduce copper loss of the motor in its entirety.

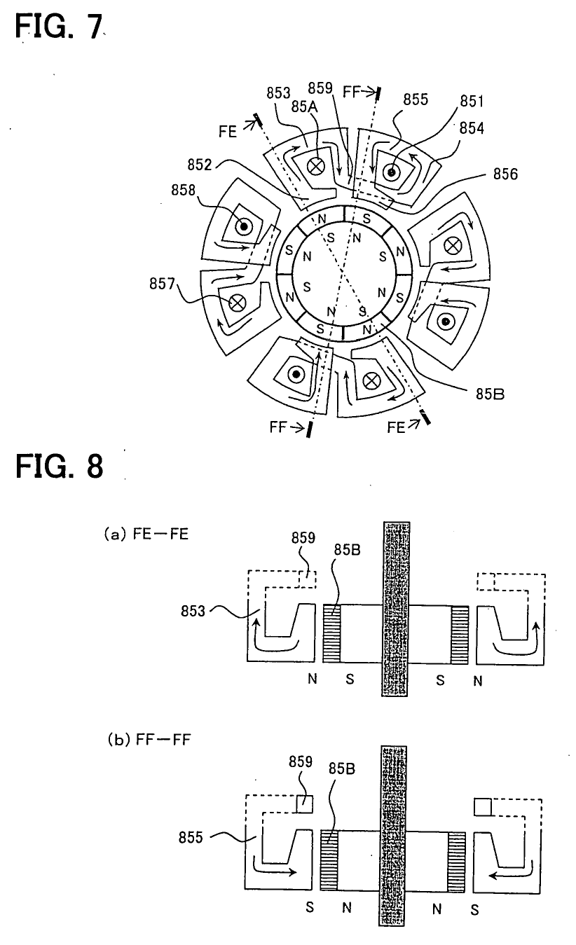

FIG. 7 shows a single-phase eight-pole AC motor. In this motor, a magnetic flux generated by each N-pole of the rotor passes through each stator pole 852 and through magnetic paths 853, 859, 854 and 855 in this order, and returns to each S-pole of the rotor through each stator pole 856. Turns of windings 851 and 85A are provided at positions where the magnetic flux passing through the above magnetic paths can make an interlinkage twice in the same direction. Thus, it is so configured that both of the currents of the winding 851 and the current of the winding 85A can give magnetomotive force to the two stator poles 852 and 856. FIG. 8 shows by (a) a cross section taken along a line FE-FE, and by (b) a cross section taken along a line FF-FF. Other components, such as windings 857 and 858, have the same configurations. In the case of the motor shown in FIGS. 7 and 8 as well, the windings 854 required for the motor shown in FIG. 3 can be eliminated. Thus, the amount of winding can be reduced to also reduce copper loss of the motor in its entirety.

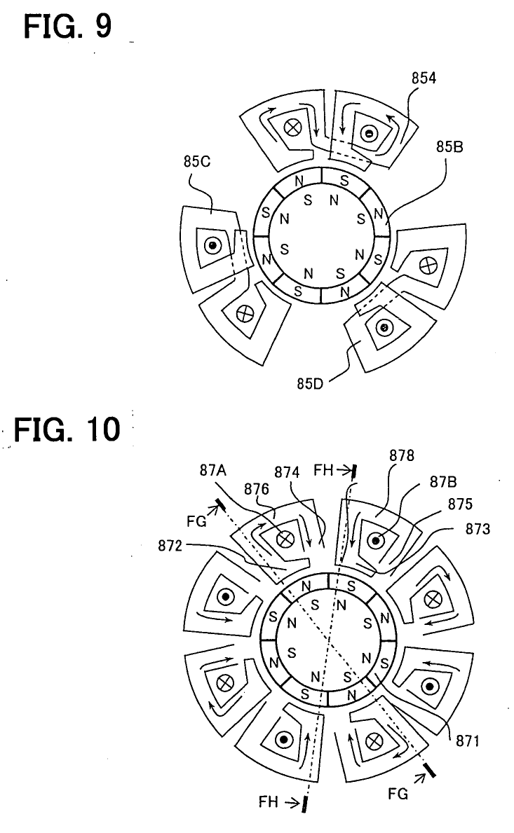

FIG. 9 shows a three-phase eight-pole AC motor. In this motor, one set out of four sets of the stator components of FIG. 7 is removed, and the three sets of components are arranged so as to have a circumferential relative phase difference of 120° in electrical angle from the rotor. For example, magnetic paths 854, 85C and 85D are arranged at positions where relative phase for the rotor is mutually different by 120° in electrical angle. In the case of the motor shown in FIG. 9 as well, the windings 854 required for the motor shown in FIG. 3 can be eliminated. Thus, the amount of winding can be reduced to also reduce copper loss of the motor in its entirety.

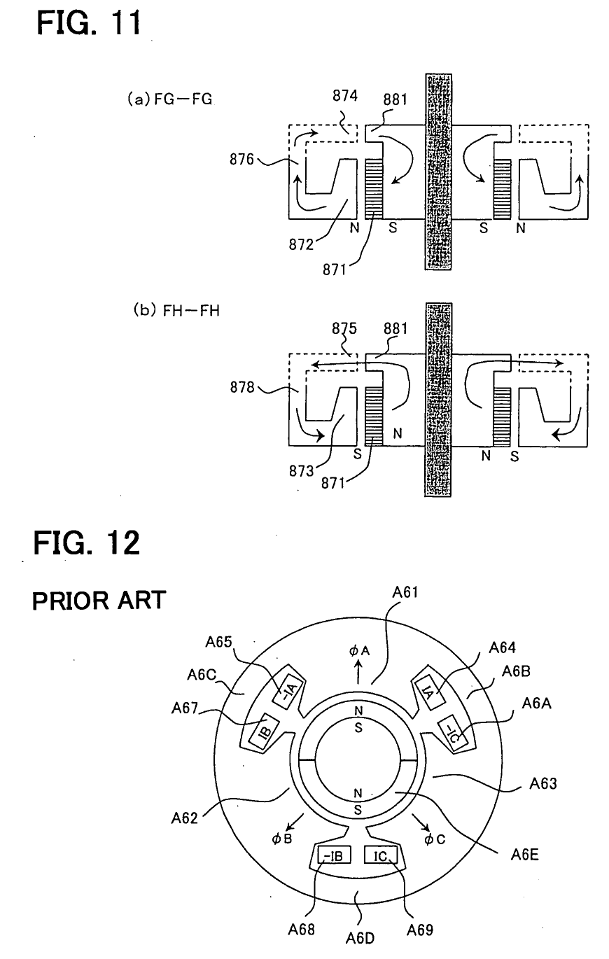

FIG. 10 shows a single-phase eight-pole AC motor. Indicated by numeral 871 are permanent magnets of a type for a surface magnet rotor, which are attached in the vicinity of the rotor surface. Indicated by numeral 872 are stator poles opposed to the N-pole magnets of the rotor. A magnetic flux from each N-pole passes through the stator pole 872 through an air gap, and passes through a magnetic path 876 and a flux-passing magnetic path 874 that serves for passing the magnetic flux to the side of the rotor. As shown by (a) of FIG. 11, a cross section taken along a line FG-FG, the flux-passing magnetic path 874 is adapted to face a flux-passing magnetic path 881 which serves for passing the magnetic flux to the side of the stator, so that the magnetic flux that passes through the flux-passing magnetic path 874 is permitted to pass through the back yoke of the rotor.

With respect to the rotor, stator poles 873 are arranged so as to have a relative phase difference of 180° in electrical angle from the stator poles 872. A magnetic flux passing through each stator pole 873 passes through a magnetic path 878, a flux-passing magnetic path 875 and the flux-passing magnetic path 881 and returns to the back yoke of the rotor. FIG. 11 shows by (b) a cross section taken along a line FH-FH.

Since there is a phase difference of 180° between windings 87A and 87B in the currents to be supplied thereto, these windings can be wound so as to serve as reciprocal windings in the rotor shaft direction. In the case of the motor shown in FIG. 10 as well, the windings 854 required for the motor shown in FIG. 3 can be eliminated. Thus, the amount of winding can be reduced to also reduce copper loss of the motor in its entirety.

The flux-passing magnetic paths 874 and 875 of the stator may not only be linked with the stator poles but also be magnetically linked with the adjacent flux-passing magnetic paths of the stator. The flux-passing magnetic path 881 of the rotor, which has a circular shape, is configured to prevent the magnetic impedance between the rotor and the stator from being varied depending on the rotational position. Accordingly, the requirements for the uniformization of the magnetic impedance may be that the flux-passing magnetic path on either the rotor or stator side has a circular shape. Modification of the flux-passing magnetic paths is available within the requirements.

Currents have to be passed through the windings shown in FIG. 10 in the directions as indicated therein, but the windings may be imparted with turns in some specific methods. Other than the method associated with the windings 87A and 87B described above, the windings may be imparted, for example, with wave winding, or alternatively, winding turns may be serially or parallelly imparted involving three or more windings indicated by winding symbols in FIG. 10.

For simplification of the indication and explanation of the configuration, the motor shown in FIG. 10 has been explained as a single-phase motor, but this motor can be configured as a three-phase AC motor as shown in FIGS. 4 and 9, for example. Alternatively, the motor may be configured as being a two-phase AC motor or multiphase AC motor having four or more phases.

FIG. 12 is a cross section of a conventional three-phase two-pole AC motor for short-pitch winding, non-overlapping winding or concentrated winding, or rather a cross section of a so-called “concentrated-winding brushless motor”. Indicated by A61 is an A-phase stator pole, by A62 is a B-phase stator pole and by A63 is a C-phase stator pole. Indicated by A64 and A65 are windings for the A-phase stator pole A61, with their currents having a value IA. Indicated by A67 and A68 are windings for the B-phase stator pole A62, with their currents having a value IB. Indicated by A69 and A6A are windings for the C-phase stator pole A63, with their currents having a value IC. Indicated by A6E are permanent magnets for the rotor, which magnets can generate torque with the supply of phase currents thereto in synchronization with the rotor.

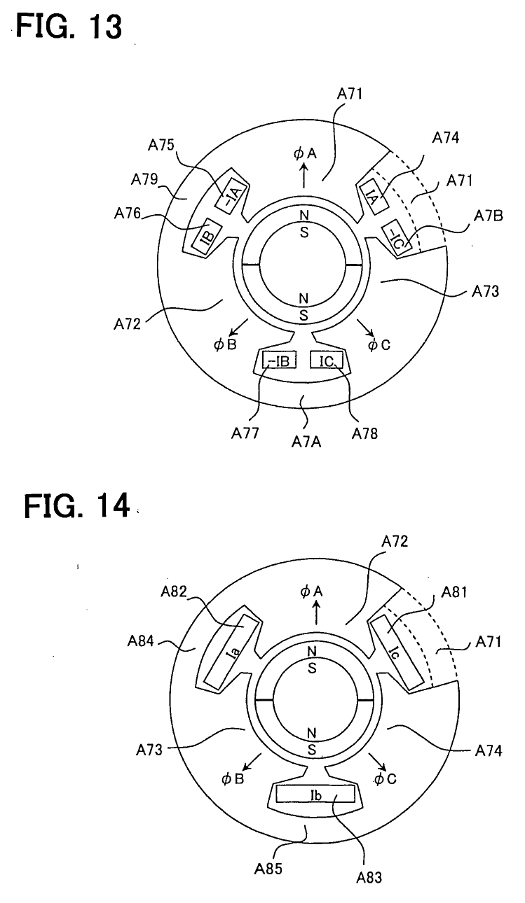

The motor shown in FIG. 13 has the same structure as the motor shown in FIG. 12 except for one portion. That is, from a magnetic path A6B shown in FIG. 12 between the A-phase stator pole A61 and the C-phase stator pole A63, a portion A71 indicated by broken lines in FIG. 13 is removed. When the rotor is rotated in the condition shown in FIG. 13, the magnetic fluxes interlinked with an A-phase winding A74 are substantially zeroed, while the magnetic fluxes interlinked with an A-phase winding A75 are increased by a factor of two comparing with the case of FIG. 12. The same applies to the phase C. That is, the magnetic fluxes interlinked with a C-phase winding A7B are substantially zeroed, while the magnetic fluxes interlinked with a C-phase winding A78 are increased by a factor of two comparing with the case of FIG. 12. The magnetic fluxes interlinked with B-phase windings A76 and A77 remain the same as shown in FIG. 12. Thus, from an electromagnetic viewpoint, this means that the windings A74 and A7B may be removed. However, some different scheme may be required for supplying currents to the windings A75 and A78. In this case, since the magnetic fluxes passing through magnetic paths A79 and A7A will be increased by a factor of two comparing with the case of FIG. 12, these magnetic paths are required to be enlarged. However, in case of a multipolarized motor, an absolute value of the thickness of the back yoke of the stator will be small, and thus the loading on the back yoke will not be large.

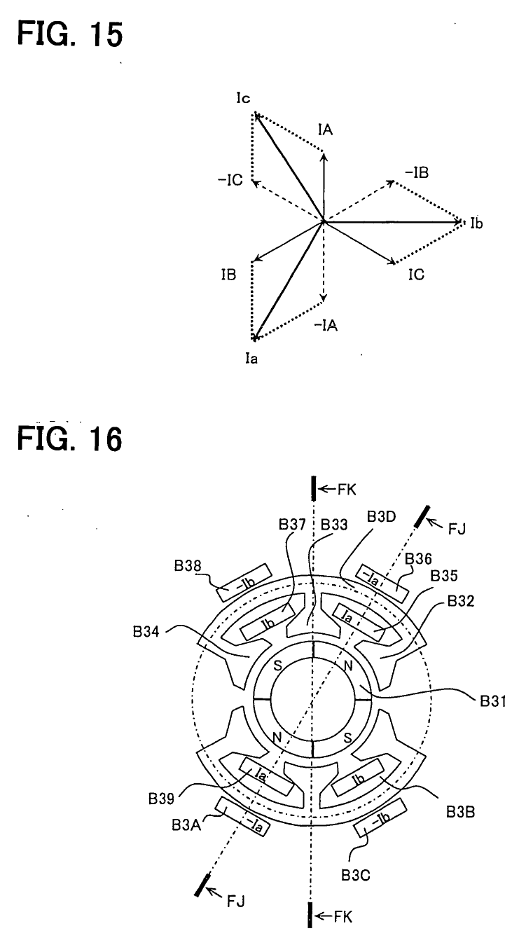

FIG. 14 shows an example in which the two windings arranged in the same one slot of the motor shown in FIG. 13 are combined into a single winding and the current passed through the combined winding is made equivalent to an arithmetic additional value of the currents passed through the two windings before being combined. For example, the windings A65 and A67 of FIG. 13 can be combined into a winding A82 of FIG. 14 with a current Ia passing therethrough being (−IA+IB). FIG. 15 shows a vectorial relationship in the additions of the currents. For example, the figure shows a relationship expressed by Ia=−IA+IB. In this case, assuming that the diameter of the winding A82 is twice as large as that of the winding A75, the current will become large by a factor of 1.732 as a result of a vectorial addition. Accordingly, copper loss, which will be expressed by (1.732/2)²=¾, will be decreased by 25%.

FIG. 16 shows a four-pole version modification of the motor shown in FIG. 14. In the motor, return wires B36, B38, B3A and B3C of windings B35, B37, B39 and B3C, respectively, are arranged at an outer periphery of the stator. These windings B36, B38, B3A and B3C are not particularly limited in the positions for arrangement if only they are arranged outside the magnetic circuits of the stator, and thus can be arranged at positions convenient for manufacture. The stator may also be modified to have a shape, for example, for enabling reduction of the length of the windings.

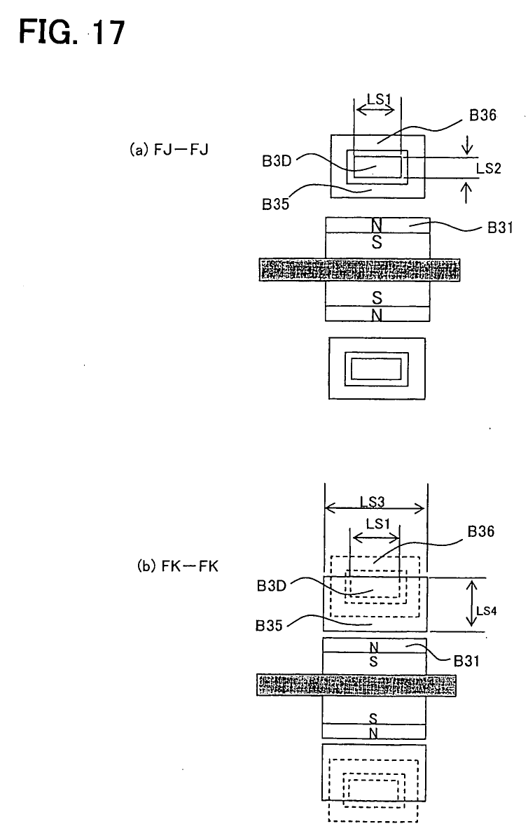

FIG. 17 shows cross sections of examples of shapes of the motor shown in FIG. 16. FIG. 17 shows by (a) a cross section taken along a line FJ-FJ of FIG. 16 and by (b) a cross section taken along a line FK-FK of FIG. 16. These are the examples in which a length LS1, in the rotor shaft direction, of a magnetic path B3D is shortened to reduce the length of the winding. FIG. 18 is a perspective view of the stator shown in FIGS. 16 and 17.

FIG. 19 shows by (a) a motor example, which is obtained by incorporating two three-phase four-pole motors of FIG. 16 at outer- and inner-diameter sides. Such a configuration may impart the currents to be passed through windings B29 and B2A with exactly reversed phases, so that these windings can serve as reciprocal windings in the rotor shaft direction. This corresponds to a condition where the winding B36 shown in FIG. 16 has been removed. The same applies to other three sets of windings shown in FIG. 19. Therefore, copper loss of the motor can be drastically reduced. FIG. 19 shows by (b) a cross section taken along a line FI-FI of (a) of FIG. 19.

Let us now compare copper loss between a four-pole version of the three-phase two-pole AC motor shown in FIG. 12 and the motor shown in FIG. 19, in which two motors are incorporated at the outer- and inner-diameter sides. As have been calculated above, combination of the two windings in the same one slot into a single winding can reduce copper loss to ¾. Elimination of the copper loss in one of the three three-phase windings may reduce the copper loss to ⅔. Combination of both of the copper loss reducing advantages can be expressed by ¾×⅔=½. Thus, qualitatively, copper loss can be reduced to ½. Further, the space after removal of a winding can be effectively utilized. Thus, coupled with the idea of reducing the winding resistance to ⅔, copper loss may be qualitatively reduced, in total, to ⅓ as can be calculated from ½×⅔=⅓.

Since the motor shown in FIG. 19 is an example of four poles, a radius of a gap portion for electromagnetically generating torque is significantly different between the outer-diameter side motor and the inner-diameter side motor. However, multipolarization of the motor may reduce the difference between the inner and outer diameters to thereby provide a practical structure.

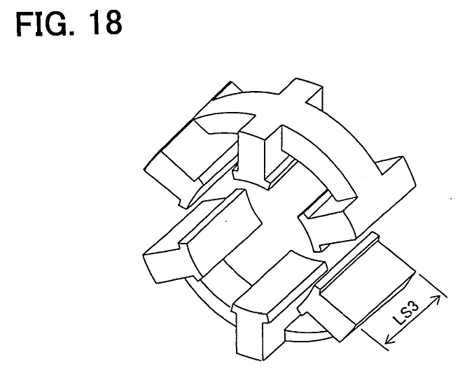

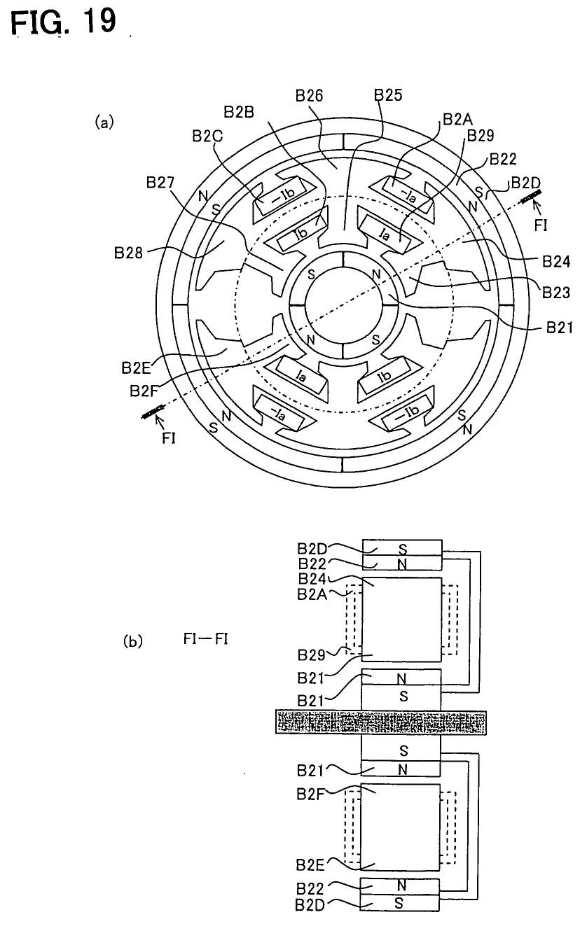

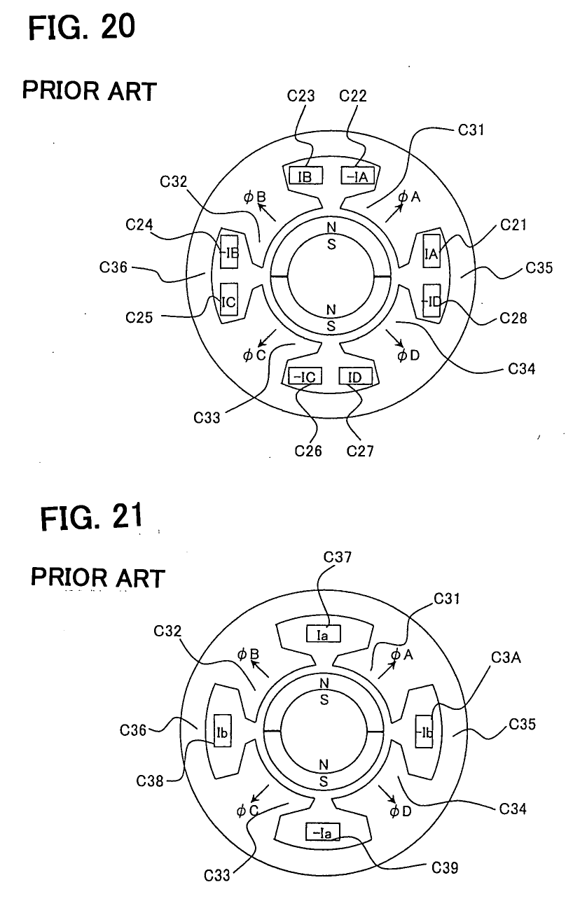

FIG. 20 shows a four-phase two-pole AC motor. In this four-phase motor as well, modification can be made in the same manner as in the case of the three-phase motor shown in FIG. 12. For combining two windings in one slot, windings C22 and C23 can be combined into a single winding C37 shown in FIG. 21. The currents may have a relationship indicated by four-phase current vectors in FIG. 23, which relationship can be expressed by Ia=−IA+IB. The same applies to other windings.

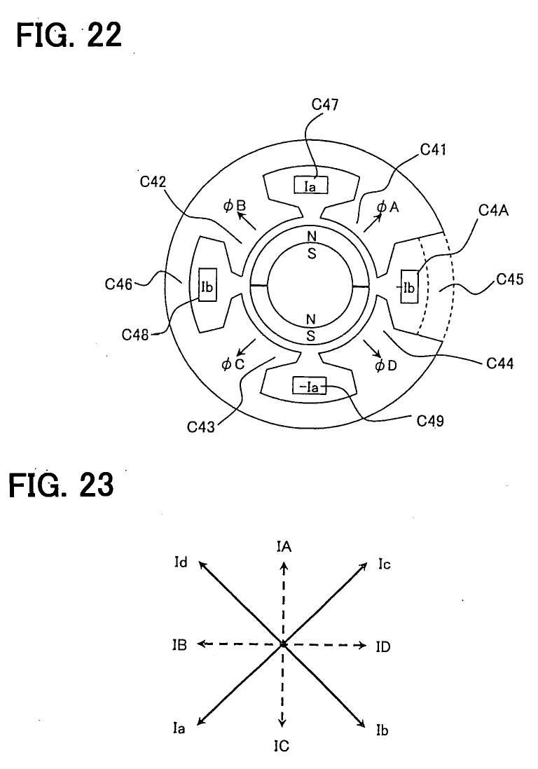

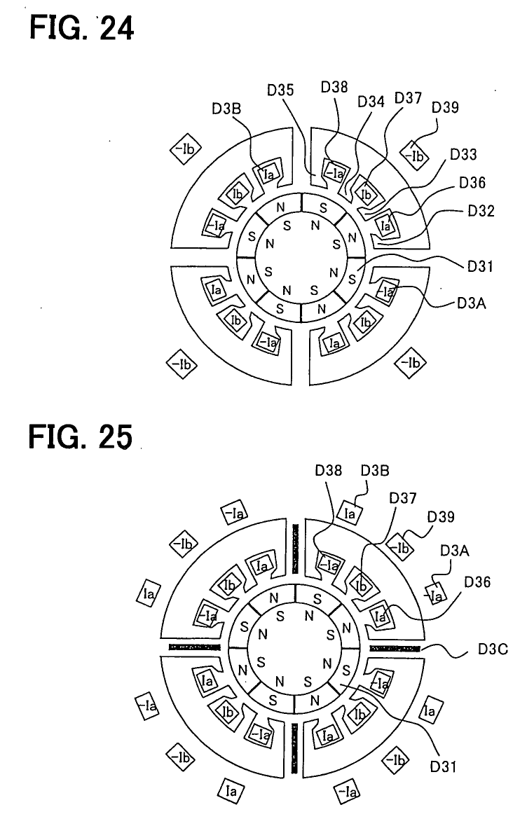

For division or partial removal of the stator core, a portion indicated by C25, for example, can be removed as shown in FIG. 22. In this case, since the magnetic fluxes interlinked with winding C4A are very small, this winding may be removed. FIG. 24 shows an eight-pole motor as modified from the two-pole motor shown in FIG. 22. In this case, windings D38 and D3B, which will have currents of reversed phases, adjacent to each other can serve as reciprocal windings in the rotor shaft direction. The same applies to windings D36 and D34. As to a winding D37, a winding D39 may be arranged at an outer side of the stator core, so that these windings can serve as reciprocal windings in the rotor shaft direction. The same applies to other windings of the motor shown in FIG. 24. Comparing with an eight-pole version of the four-phase motor shown in FIG. 21, the motor shown in FIG. 24 can realize a motor configuration with short coil ends, and thus can contribute to the size reduction.

FIG. 25 shows an example of a four-phase motor, in which return wires of three windings are all arranged at an outer side of the stator core to achieve ring winding. At first glance, the number of the windings may be disadvantageously increased, however, such a configuration may have good fabrication properties of the windings in case of a flat multipole motor having a small thickness in the rotor shaft direction. In addition, such a configuration may allow the coil ends to be short. Thus, a small size motor can be realized at low cost.

Indicated by D3C are nonmagnetic members for reducing flux leakage between adjacent stator cores. Conductors having good electrical conductivity may be used for these members to positively reduce the flux leakage by eddy currents.

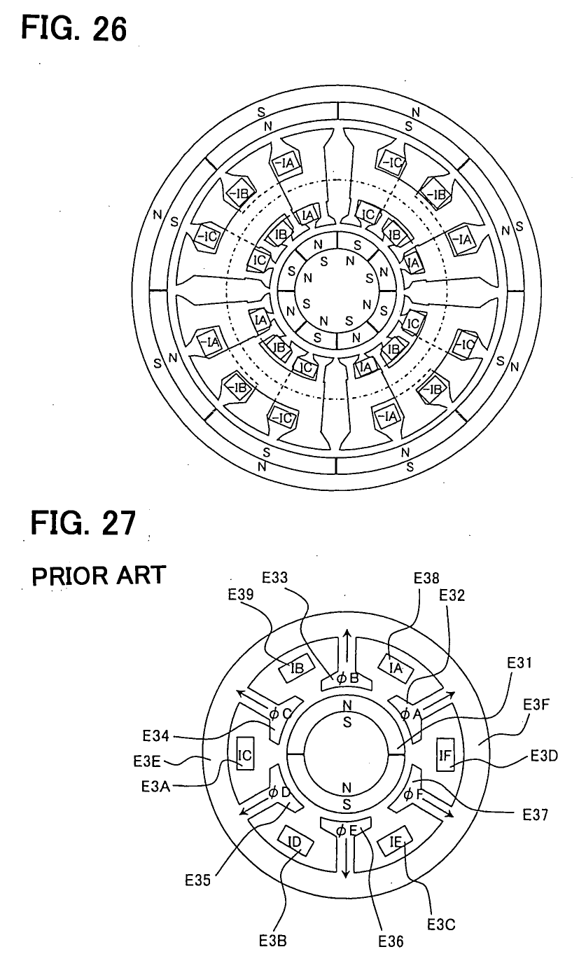

FIG. 26 shows a four-phase 8-pole motor based on the motor shown in FIG. 22 with two motors being arranged on the inner- and outer-diameter sides. This motor has advantages similar to those of the incorporated three-phase AC motor shown in FIG. 19, in which windings can be effectively arranged to reduce copper loss, improve efficiency and reduce size. The motor shown in FIG. 26 can also easily obtain substantial advantages when multipolarized.

FIG. 27 shows an example of a six-phase two-pole motor. This motor is generally called a three-phase AC motor, however, it is expressed here a six-phase motor because what is discussed here is the motor configuration focused on the vector, the phase and the number of stator poles.

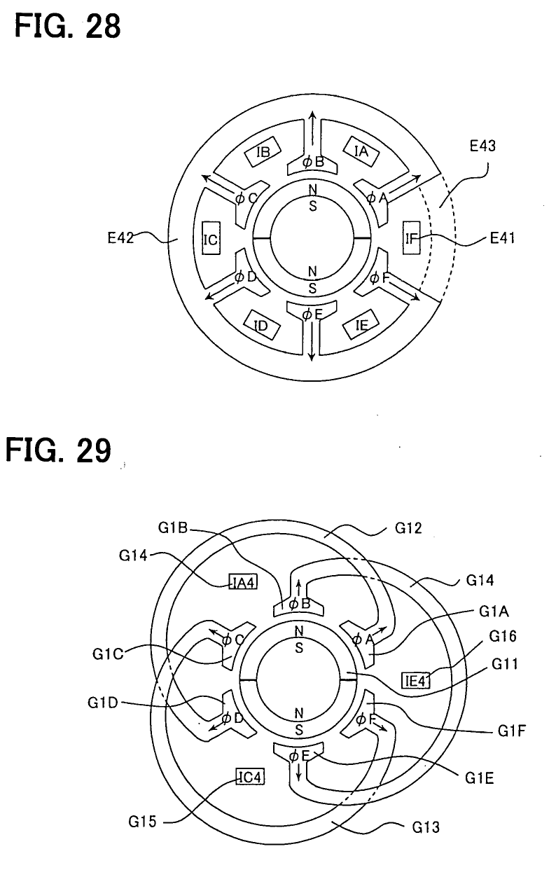

As in the cases of the three- and four-phase motors shown in FIGS. 14 and 22, the six-phase motor shown in FIG. 27 may have a configuration shown in FIG. 28, in which a portion E43 indicated by the broken lines is removed.

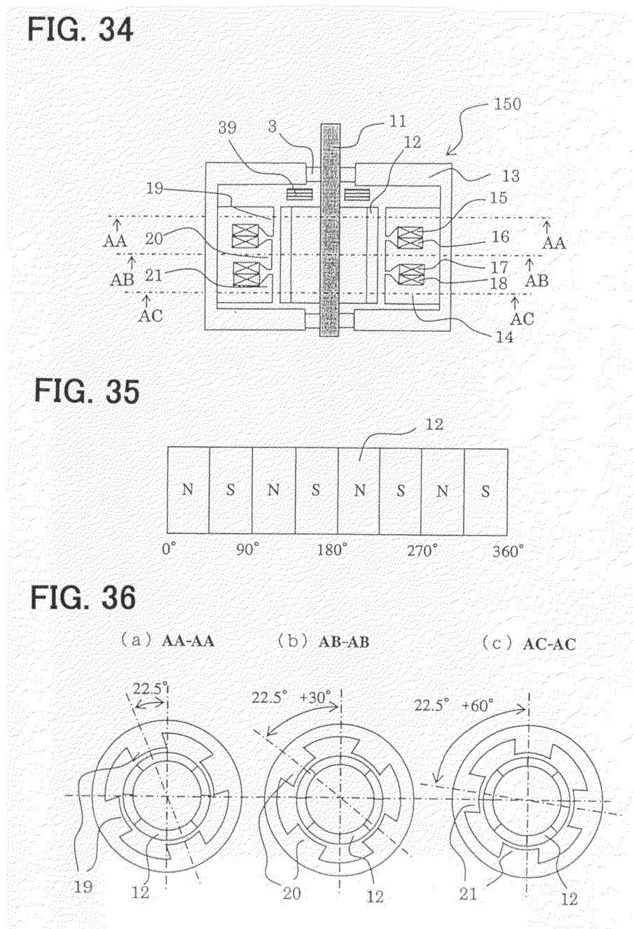

FIG. 29 shows a motor having a configuration in which the stator poles having a phase difference of 180° in electrical angle in FIG. 27 are magnetically linked through magnetic paths G12, G13 and G14 in an independent manner. Magnetic fluxes passing through the magnetic paths G12, G13 and G14 are magnetically separated from each other in the rotor shaft direction without crossing each other. When three-phase currents IA4, IC4 and IE4 indicated by current vectors in FIG. 34 are passed through windings G14, G15 and G16, magnetomotive force can be applied to each of stator poles G1A, G1B, G1C, G1D, G1E and G1F.

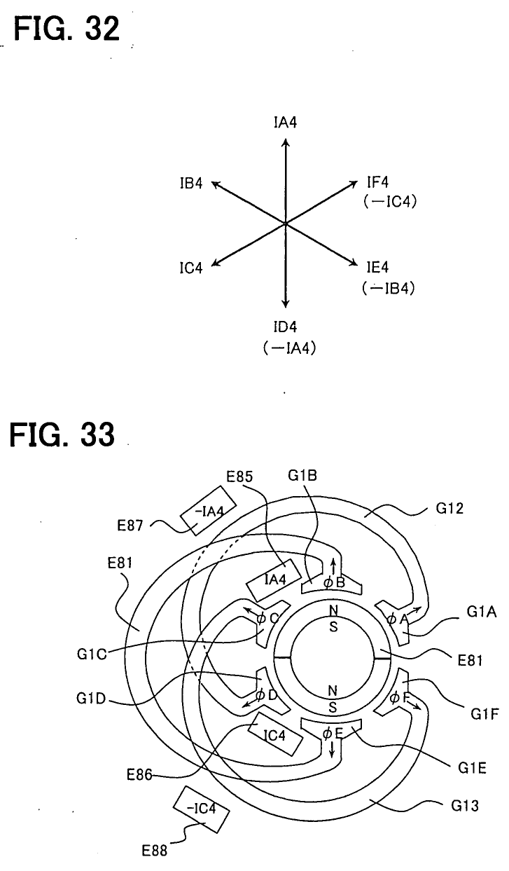

In the winding configuration of FIG. 29, however, the wiring can be passed with the currents indicated by the current vectors in FIG. 32 only when the number of turns is one. Each of FIGS. 29, 30, 31 and 33 shows a magnetic path configuration of the stator in a schematic manner. Practical magnetic path configurations having shapes as shown in FIGS. 27, 28, 11 and 18 can be obtained through modification.

In the motor shown in FIG. 30, the current IE4 of the winding G16 is replaced by currents −IA4 and −IC4 passing through respective windings E87 and E88. This utilizes a relationship expressed by IA4+IC+IE4=0. Thus, in the motor of FIG. 30, the windings G14 and E87 can be reciprocally wound in the rotor shaft direction, and the windings G15 and E88 can be reciprocally wound in the rotor shaft direction.

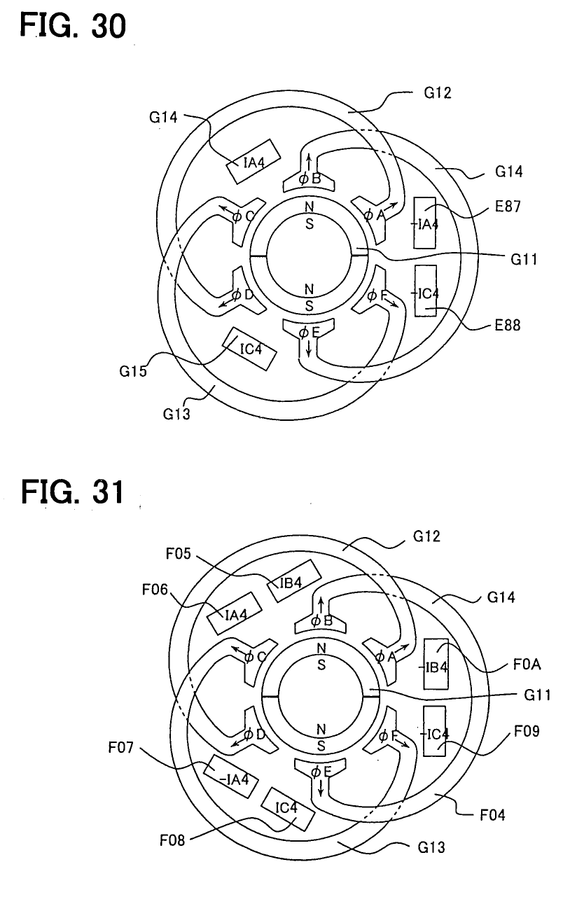

The motor shown in FIG. 29 can also be modified as shown in FIG. 31. Specifically, the current IA4 of the winding G14 can be substituted with the currents IA4 and IB4 of FIG. 32, the current IC4 of the winding G15 can be substituted with the currents IC4 and ID4 of FIG. 32, and the current IE4 of the winding G16 can be substituted with the currents IE4 and IF4 of FIG. 32. Then, the currents ID4, IE4 and IF4 can be replaced by currents −IA4, −IB4 and −IC4 to obtain the motor configuration of FIG. 31 can be obtained. In this configuration, each of the windings can be reciprocally wound in the rotor shaft direction, with the winding factor of each winding being 0.866 which is not so low. It should be appreciated that conversion is required for the magnitude of the current, which is increased by a factor of 1.732, and the phase which is offset by 30° in electrical angle.

FIG. 33 shows an example of modification of the motor shown in FIG. 32. Currents which are permitted to interlink with the magnetic path G14 in order to excite the stator poles G1B and G1E of phases B and E, respectively, are the currents −IA4 and −IC4 of the windings F87 and E88, respectively. In the case the magnetic path G14 of FIG. 30 is reversely arranged with respect to the rotor as indicated by E81 in FIG. 33, reference symbols of the interlinking currents will be reversed, so that the currents IA4 and IC4 of the windings E85 and E86, respectively, can be appropriately used. This means that the two windings E85 and E86 have given magnetomotive force of six phases to the stator poles G1A, G1B, G1C, G1D, G1E and G1F.

In the motor configuration shown in FIG. 33, the windings E87 and E88 are additionally provided as return wires for the windings E85 and E86 in the rotor shaft direction. However, since the windings E87 and E88 do not influence the motor in an electromagnetic manner, the windings E87 and E88 may be removed by elaborating the motor configuration or incorporating motors as shown in FIG. 19.

Comparing with the winding G14 of the motor shown in FIG. 30, the winding E85 of the motor shown in FIG. 33 is interlinked with magnetic fluxes by a factor of 1.732. Thus, the induced voltage constant and torque constant of the winding E85 are larger by a factor of 1.732. Accordingly, the motor configuration shown in FIG. 33 has a great significance from the viewpoints of enhancing efficiency and reducing size.

The applicant has developed related art of “AC motor and control unit therefor” (Japanese Patent Laid-Open No. 2005-160285) which includes a technique common to the motor of the present invention. The contents of the related art have already been made public. Since the related art contains the common technique in part, which technique corresponds to the mode of the motor that is the object of the present invention, the part of the related art will be explained below. As to the other parts of the related art, explanation will be omitted.

### RELATED ART

FIG. 34 shows a cross section of a brushless motor of the related art. A brushless motor 150 shown in FIG. 34 is an eight-pole motor which is operated with three-phase alternating current. The brushless motor 150 includes a rotor 11, permanent magnets 12 and a stator 14.

The rotor 11 is provided with a plurality of permanent magnets 12 which are arrange on the surface thereof. The permanent magnets 12 are arranged so that N-poles and S-poles are circumferentially alternated along the surface of the rotor 11. FIG. 35 is a circumferential development of the rotor 11. The horizontal axis indicates mechanical angle. Mechanical angle of 360° corresponds to electrical angle of 1440°.

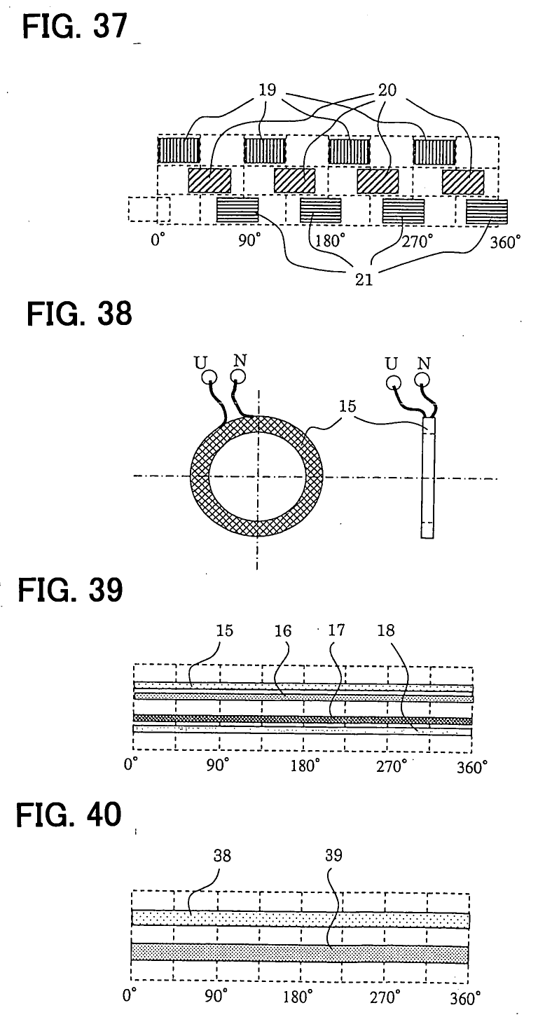

The stator 14 includes four U-phase stator poles 19, four V-phase stator poles 20 and four W-phase stator poles 21. Each of the stator poles 19, 20 and 21 has a salient shape for the rotor 11. FIG. 37 is a development of an inner configuration of the stator 14 as viewed from the side of the rotor 11. The four U-phase stator poles 19 are arranged along the same circumference with an even interval therebetween. Similarly, the four V-phase stator poles 20 are arranged along the same circumference with an even interval therebetween. The four W-phase stator poles 21 are arranged along the same circumference with an even interval therebetween. The four U-phase stator poles 19 are referred to a U-phase stator pole group. The four V-phase stator poles 20 are referred to a V-phase stator pole group. The four W-phase stator poles 21 are referred to a W-phase stator pole group. In these stator pole groups, the U-phase stator pole group and the W-phase stator pole group, which are arranged at the ends in the axial direction, are referred to end stator pole groups. The remaining V-phase stator pole group is referred to an intermediate stator pole group.

The U-phase stator poles 19, the V-phase stator poles 20 and the W-phase stator poles 21 are arranged being shifted from each other in the axial and circumferential directions. Specifically, the stator pole groups are arranged being circumferentially shifted from each other so as to have a phase difference of 30° in mechanical angle which corresponds to 120° in electrical angle. Broken lines in FIG. 37 indicate the permanent magnets 12 of the opposed rotor 11. Rotor poles of the same pole (i.e. the N-pole permanent magnets 12 and the S-pole permanent magnets 12) have an electrical angular pitch of 360°, and the stator poles of the same phase also have an electrical angular pitch of 360°.

A U-phase winding 15, V-phase windings 16 and 17, and a W-phase winding 18 are arranged between the U-phase stator poles 19, the V-phase stator poles 20 and the W-phase stator poles 21. FIG. 39 is a circumferential development of the windings of the individual phases. The U-phase winding 15 is provided between the U-phase stator poles 19 and the V-phase stator poles 20 and has a shape looped along the circumference. When a clockwise current as viewed from the side of the rotor 11 is positive (the same applies to the windings of other phases), the current passing through the U-phase winding 15 is negative (−Iu). Similarly, the V-phase winding 16 is arranged between the U-phase stator poles 19 and the V-phase stator poles 20 and has a shape looped along the circumference. A current Iv passing through the V-phase winding 16 is positive (+Iv). The V-phase winding 17 is arranged between the V-phase stator poles 20 and the W-phase stator poles 21 and has a shape looped along the circumference. A current Iv passing through the V-phase winding 17 is negative (−Iv). The W-phase winding 18 is arranged between the V-phase stator poles 20 and the W-phase stator poles 21 and has a shape looped along the circumference. A current Iw passing through the W-phase winding 18 is positive (+Iw). These three types of currents Iu, Iv and Iw are three-phase alternating currents whose phases are shifted from each other by 120°. Indicated by numeral 39 is a winding for cancelling axial magnetomotive force.

Hereinafter are described in detail the stator pole and winding configurations of the individual phases. FIG. 36 shows cross sections of the stator 14 shown in FIG. 34. FIG. 36 shows by (a) a cross section taken along a line AA-AA, by (b) a cross section taken along a line AB-AB and by (c) a cross section taken along a line AC-AC. As shown in FIG. 36, the U-, V- and W-phase stator poles 19, 20 and 21 have a salient shape for the rotor 11, and are arranged so as to have a positional relationship where there is a phase difference of 30° in mechanical angle from each other, which corresponds to 120° in electrical angle.

FIG. 38 schematically shows front and lateral views of the configuration of the U-phase winding 15. The U-phase winding 15 has a winding-start terminal U and a winding-end terminal N. Similarly, the windings 16 and 17 have winding-start terminals V and winding-end terminals N. The W-phase winding 18 has a winding-start terminal W and a winding-end terminal N. In the case where the phase windings are imparted with three-phase Y connection, the winding-end terminals N of these phase windings 15, 16, 17 and 18 are connected. The currents Iu, Iv and Iw passing through the phase windings 15, 16, 17 and 18 are controlled to have current phases that generate torque between the stator poles 19, 20 and 21 of the individual phases and the permanent magnets 12 of the rotor 11. These currents are also controlled to have a relationship expressed by Iu+Iv+Iw=0.

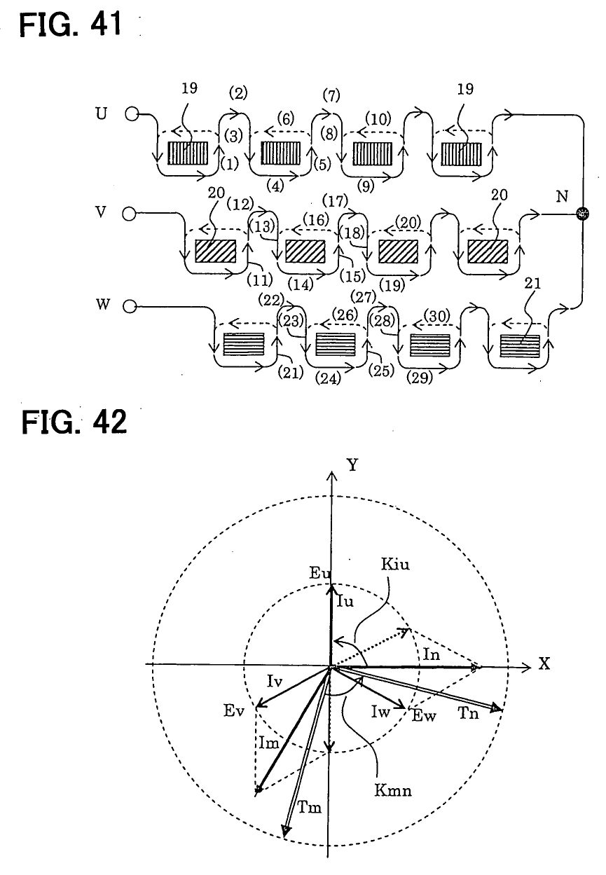

Hereinafter will be explained a relationship between these phase currents Iu, Iv and Iw and the magnetomotive force applied to the stator poles 19, 20 and 21 of the individual phases by these currents. FIG. 41 is a development based on the development (FIG. 37) of the stator poles 19, 20 and 21 of the individual phases as viewed from the side of an air gap surface (the side of the rotor 11), with an addition of equivalent current windings of the individual phases.

Wires of the U-phase winding are unidirectionally connected in series and wound about the four U-phase stator poles 19. Accordingly, the U-phase stator poles 19 are unidirectionally imparted with magnetomotive force. For example, the U-phase winding wires wound about the second U-phase stator pole 19 from the left in FIG. 41 consist of wires (3), (4), (5) and (6). These wires are wound, in this order, about the U-phase stator pole 19 for a plurality of times. Wires (2) and (7) are connecting wires for the adjacent U-phase stator pole 19 and have no electromagnetic effect.

Detailed study on portions of the current Iu flowing through such a U-phase winding reveals that magnitudes of the currents in the wires (1) and (3) are the same but the currents flow in the opposite direction from each other, so that the magnetomotive force ampere turn is offset. Accordingly, these wires can be regarded as being in a state equivalent to the state where no current is passed. Similarly, as to currents in the wires (5) and (8), the magnetomotive force ampere turn is offset. Thus, these wires can be regarded as being in a state equivalent to the state where no current is passed. Thus, since the currents passing through the wires disposed between the U-phase stator poles 19 are constantly offset, there is no need to pass currents, leading to the possible removal of the wires concerned. As a result, it can be regarded that the U-phase loop current Iu passing along the circumference of the stator 14 for the wires (10) and (6) flows simultaneously with the U-phase loop current −Iu passing along the circumference of the stator 14 for the wires (4) and (9).

Moreover, the U-phase loop current Iu passing along the circumference of the stator 14 for the wires (10) and (6), is a looped current that passes outside the stator core. Outside the stator core, there exists air, for example, having large magnetic resistance, and therefore the loop current can exert little electromagnetic effect on the brushless motor 15. Thus, omission of the loop current may involve no influence, leading to possible removal of the loop winding positioned outside the stator core. (Although this loop winding is omitted in the above example, it may be left without being removed.) Consequently, the effects of the U-phase winding shown in FIG. 34 can be regarded as being equivalent to those of the U-phase loop windings 15 shown in FIGS. 34 and 39.

Wires of the V-phase winding shown in FIG. 41 are convolutedly and serially wound about the four V-phase stator poles 20 as in the case of the U-phase winding. In the winding, currents flowing through the wires (11) and (13) have the same magnitude but are oppositely directed, so that the magnetomotive force ampere turn is offset. Accordingly, these wires can be regarded as being in a state equivalent to the state where no current is passed. Similarly, the magnetomotive force ampere turn is offset as to the currents flowing through the wires (15) and (18). As a result, it can be regarded that the V-phase loop current Iv passing along the circumference of the stator 14 for the wires (20) and (16) flows simultaneously with the V-phase loop current −Iv passing along the circumference of the stator 14 for the wires (14) and (19). Consequently, the effects of the V-phase winding shown in FIG. 34 can be regarded as being equivalent to those of the V-phase loop windings 16 and 17 shown in FIGS. 34 and 39.

Wires of the W-phase winding shown in FIG. 41 is convolutedly and serially wound about the four W-phase stator poles 21 as in the case of the U-phase winding. In the winding, currents flowing through the wires (21) and (23) have the same magnitude but are oppositely directed, so that the magnetomotive force ampere turn is offset. Accordingly, these wires can be regarded as being in a state equivalent to the state where no current is passed. Similarly, the magnetomotive force ampere turn is offset as to the currents flowing through the wires (25) and (28). As a result, it can be regarded that the W-phase loop current Iw passing along the circumference of the stator 14 for the wires (30) and (26) flows simultaneously with the W-phase loop current −Iw passing along the circumference of the stator 14 for the wires (24) and (29).

Moreover, the W-phase loop current −Iw passing along the circumference of the stator 14 for the wires (24) and (29) mentioned above is a loop current that passes outside the stator core. Outside the stator core, there exists air, for example, having large magnetic resistance, and therefore the loop current can exert little electromagnetic effect on the brushless motor 15. Thus, omission of the loop current may involve no influence, leading to possible removal of the loop winding positioned outside the stator core. Consequently, the effects of the W-phase winding shown in FIG. 41 can be regarded as being equivalent to those of the looped W-phase winding 18 shown in FIGS. 34 and 39.

As described above, windings and current that impart the stator poles 19, 20 and 21 of the individual phases of the stator 14, with electromagnetic effects can be replaced by simplified loop windings. In addition, the loop windings at the axial ends of the stator 14 can be removed. As a result, the amount of copper used for the brushless motor 15 can be significantly reduced to thereby enable achievement of high efficiency and high torque. Also, since there is no need of circumferentially arranging winding (wires) between the stator poles of the same phase, a multipole structure beyond the conventional structure can be achieved. In particular, the simplified winding structure can enhance the productivity of motors with reduced cost.

It should be appreciated that, magnetically, magnetic fluxes φu, φv and φw that pass through the U-, V- and W-phase stator poles, respectively, merge together at a back yoke to establish a relation in which a sum total of the 3-phase AC magnetic fluxes is “0” as expressed by an equation: φu+φv+φw=0. The conventional structure shown in FIGS. 264, 265 and 266 is a structure where two each of the salient poles 19, 20 and 21, i.e. six in total, shown in FIG. 41 are arranged along the same circumference, with each of the salient poles exerting the same electromagnetic effect and torque generation as in the brushless motor 150. However, unlike the brushless motor 150 shown in FIGS. 34 to 40, the conventional brushless motor shown in FIGS. 264 and 265 cannot be removed with portions of the winding or cannot have simplified winding for structural reasons.

The brushless motor 150 has the configuration as described above. The operation of the brushless motor 150 will now be explained. FIG. 42 is a vector diagram illustrating currents, voltages and output torque of the brushless motor 150. The X-axis corresponds to a real axis and the Y-axis corresponds to an imaginary axis. Counterclockwise angles with respect to the X-axis are vector phase angles.

The rotation angle rate of the fluxes φu, φv and φw that are present in the stator poles 19, 20 and 21 of the individual phases of the stator 14 are referred to herein as a “unit voltage”, and thus relations are provided as Eu=dφ/dθ, Ev=dφv/dθ and Ew=dφw/dθ. The relative positions of the phase stator poles 19, 20 and 21 for the rotor 11 (permanent magnets 12) are shifted by 120° in electrical angle as shown in FIG. 37. Accordingly, as shown in FIG. 42, the unit voltages Eu, Ev and Ew induced by one turn of the phase windings 15 to 18, result in 3-phase AC voltages.

On condition that the rotor rotates at constant rotation dθ/dt=S1, and the number of turns of the phase windings 15 to 18 are Wu, Wv and Ww with each of these values being equal to Wc, the induction voltages Vu, Vv and Vw of the windings 15 to 18 are expressed by the following Formulas. It should be appreciated that ignorance of flux components leaked from the stator poles may result in the number of flux linkages as being Wu×φu in the U-phase winding, Wv×φv in the V-phase winding and Ww×φw in the W-phase winding.

$$\begin{matrix}\begin{matrix}Vu = Wu \times ( - d φ u / d t ) \\ = - Wu \times d φ u / d θ \times d θ / d t \\ = - Wu \times Eu \times S 1\end{matrix} \\ Similarly , & ( 1 ) \\ Vv = Wv \times Ev \times S 1 & ( 2 ) \\ Vw = Ww \times Ew \times S 1 & ( 3 )\end{matrix}$$

Particular relationship between the windings and the voltages are as follows. The unit voltage Eu of the U-phase is a voltage generated at one reverse turn of the U-phase winding 15 shown in FIGS. 34 and 39. The U-phase voltage Vu is a voltage generated in a reverse direction in the U-phase winding 15. The unit voltage Ev of the V-phase is a voltage generated across a serial connection of one turn of the V-phase winding 16 and one reverse turn of the V-phase winding 17. The V-phase voltage Vv is a voltage across a serial connection of the V-phase winding 16 and the reverse V-phase winding 17. The unit voltage Ew of the W-phase is a voltage generated at one turn of the W-phase winding 18 shown in FIGS. 34 and 39. The W-phase voltage Vw is a voltage generated in a reverse direction in the W-phase winding 18.

In order to efficiently generate torque in the brushless motor 150, the phase currents Iu, Iv and Iw are required to be fed to the same phases as the unit voltages Eu, Ev and Ew, respectively, of the phase windings. In FIG. 42, Iu, Iv and Iw are assumed to reside in the same phases as Eu, Ev and Ew, respectively, and the voltage vector and the current vector of the same phase are represented by a single vector arrow for simplification of the vector diagram.

An output power Pa and phase powers Pu, Pv and Pw of the brushless motor 150 are expressed by the following Formulas:

Pu=Vu×(−Iu)=Wu×Eu×S1×Iu (4)

Pv=Vv×Iv=Wv×Ev×S1×Iv (5)

Pw=Vw×Iw=Ww×Ew×S1×Iw (6)

Pa=Pu+Pv+Pw=Vu×Iu+Vv×Iv+Vw×Iw (7)

Further, an output torque Ta and phase torques Tu, Tv and Tw of the brushless motor 150 are expressed by the following Formulas:

$$\begin{matrix}Tu = Pu / S 1 = Wu \times Eu \times Iu & ( 8 ) \\ Tv = Pv / S 1 = Wv \times Ev \times Iv & ( 9 ) \\ Tw = Pw / S 1 = Ww \times Ew \times Iw & ( 10 ) \\ \begin{matrix}Ta = Tu + Tv + Tw \\ = Wu \times Eu \times Iu + Wv \times Ev \times Iv + Ww \times Ew \times Iw \\ = Wc \times ( Eu \times Iu + Ev \times Iv + Ew \times Iw )\end{matrix} & ( 11 )\end{matrix}$$

It should be appreciated that the vector diagram associated with the voltages, currents and torques of the brushless motor 150 according to the present embodiment is the same as the vector diagram associated with the conventional brushless motor shown in FIGS. 264, 265 and 266.

An explanation will now be given on an approach for modifying the phase windings and currents shown in FIGS. 34 and 39, which modification may attain higher efficiency. The U-phase winding 15 and the V-phase winding 16 are loop windings, which are adjacently arranged between the U-phase stator poles 19 and the V-phase stator poles 20. These windings can be combined into a single winding. Similarly, the V-phase winding 17 and the W-phase winding 18 are loop windings, which are adjacently arranged between the V-phase stator poles 20 and the W-phase stator poles 21. These windings can be combined into a single winding.

FIG. 40 shows the modification in which two windings are combined into a single winding. As is apparent from the comparison between FIGS. 40 and 39, the U-phase winding 15 and the V-phase winding 16 are replaced by a single M-phase winding 38, and the V-phase winding 17 and the W-phase winding 18 are replaced by a single N-phase winding 39. The current (−Iu) of the U-phase winding 15 and the current (Iv) of the V-phase winding 16 are added to obtain an M-phase current Im (=−Iu+Iv) for passing through the M-phase winding 38. The condition of magnetic flux generated by the M-phase winding 38 results in the same as that of the magnetic flux obtained by combining the magnetic fluxes generated by the U- and V-phase windings 15 and 16, thereby attaining electromagnetic equivalence between these conditions. Similarly, the current (−Iv) of the V-phase winding 17 and the current (Iw) of the W-phase winding 18 are added to obtain an N-phase current In (=−Iv+Iw) for passing through the N-phase winding 39. The condition of magnetic flux generated by the N-phase winding 39 results in the same as that of the magnetic flux obtained by combining the magnetic fluxes generated by the V- and W-phase windings 17 and 18, thereby attaining electromagnetic equivalence between these conditions.

These conditions are reflected on FIG. 42. A unit voltage Em of the M-phase winding 38 and a unit voltage En of the N-phase winding 39 shown in FIG. 42 are expressed by the following Formulas:

Em=−Eu=−dφu/dθ

En=Ew=dφw/dθ

Further, vector calculations of voltage V, power P and torque T of the individual windings result in the following Formulas:

$$\begin{matrix}Vm = Wc \times Em \times S 1 & ( 12 ) \\ Vn = Wc \times En \times S 1 & ( 13 ) \\ \begin{matrix}Pm = Vm \times Im = Wc \times ( - Eu ) \times S 1 \times ( - Iu + Iv ) \\ = Wc \times Eu \times S 1 \times ( - Iu + Iv )\end{matrix} & ( 14 ) \\ Pn = Vn \times In = Wc \times Ew \times S 1 \times ( - Iv + Iw ) & ( 15 ) \\ Pb = Pm + Pn = Vu \times ( - Iu + Iv ) + Vw \times ( - Iv + Iw ) & ( 16 ) \\ Tm = Pm / S 1 = Wc \times ( - Eu ) \times ( - Iu + Iv ) & ( 17 ) \\ Tn = Pn / S 1 = Wc \times Ew \times ( - Iv + Iw ) & ( 18 ) \\ \begin{matrix}Tb = Tm + Tn = Wc \times ( ( - Eu \times In ) \\ = Wc \times ( - Eu \times ( - Iu + Iv ) + Ew \times ( - Iv + Iw ) ) \\ = Wc \times Eu \times Iu + Wc \times Iv \times ( - Eu - Ew ) + Wc \times Ew \times Iw\end{matrix} & ( 19 ) \\ = Wc \times ( Eu \times Iu + Ev \times Iv + Ew \times Iw ) \\ because , & ( 20 ) \\ Eu + Ev + Ew = 0 & ( 21 )\end{matrix}$$

The torque formula indicated by Formula (11) is expressed by three phases, while the torque formula indicated by Formula (19) is expressed by two phases. Although the expressions of these torque formulas are different, expansion of Formula (19) results in Formula (20). As can be seen, therefore, these Formulas are mathematically equivalent. In particular, in case the voltages Vu, Vv and Vw and the currents Iu, Iv and Iw are balanced three-phase alternating currents, the torque Ta expressed by Formula (11) results in a steady value. In this case, the torque Tb expressed by Formula (19) is obtained as a sum of square function of the sine wave, as shown in FIG. 42, which is a phase difference, i.e. Kmn=90°, between Tm and Tn, and results in a steady value.

Formula (19) is an expression of a mode of a 2-phase AC motor, and Formulas (11) and (21) are expressions of modes of a 3-phase AC motor. These values are the same. However, in Formula (19), a copper loss is different between a case where the current Im for (−Iu+Iv) is supplied to the M-phase winding 38 and a case where the currents −Iu and Iv are supplied to the U- and V-phase windings 15 and 16, respectively, although there is no electromagnetic difference. As shown in the vector diagram of FIG. 42, a real axis component of the current Im is reduced to a value obtained by multiplying Im with cos 30°. Accordingly, supplying the current Im to the M-phase winding 38 may result in a copper loss of 75%, exerting an effect of reducing copper loss by 25%.

Combination of the adjacently arranged loop windings can not only reduce copper loss but also simplify the winding structure. As a result, the productivity of motors can be more enhanced and the cost can be more reduced.

Hereinafter will be described a modification in the shapes of the poles in gap surfaces, associated with the configuration of the stator 14 of the motor shown in FIG. 34. The shapes of the poles of the stator 14 give significant influences on torque characteristics, and are closely related to cogging torque ripple, or torque ripple induced by supply current. A specific example will be described, in which shapes of the stator poles in the individual groups of stator poles are modified, so that a configuration and amplitude of each unit voltage, that is, a rotation change rate of the magnetic flux that resides in each group of stator poles may be substantially kept at a certain level and that a phase difference of 120° in electrical angle can be maintained.

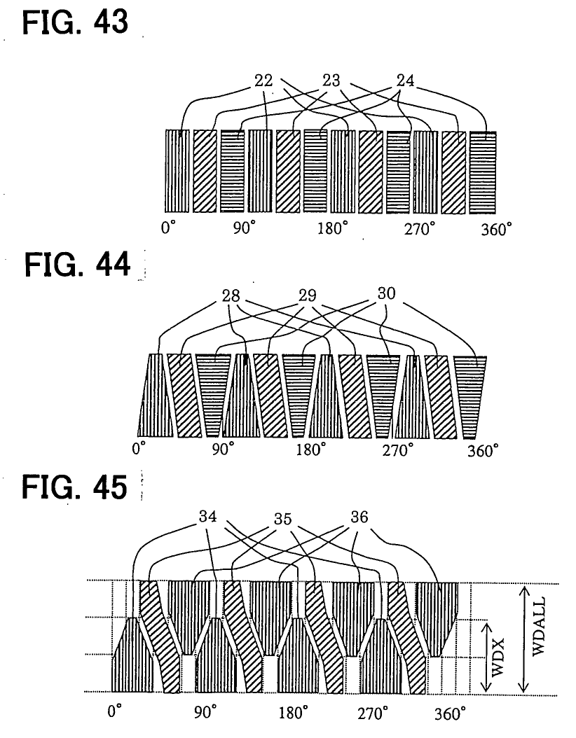

FIG. 43 is a circumferential development of modified stator poles. Stator poles 22, 23 and 24 of the individual phases shown in FIG. 37 have basic shapes, being arranged parallel to the rotor shaft 11. The stator poles in each phase have the same shapes and are arranged so as to have a relative phase difference of 120° in electrical angle. There is concern that use of the stator poles 22, 23 and 24 having such shapes may induce larger torque ripple. In this regard, formation of domed indents in a radial direction of the stator poles 22, 23 and 24 may allow smooth electromagnetic effects at border portions, by which torque ripple can be reduced. Alternatively, domed indents may be formed in individual pole surfaces of the permanent magnets 12 of the rotor 11 to realize a sinusoidal magnetic flux distribution in a circumferential direction, by which torque ripple can be reduced. The angles indicated by the horizontal axis of FIG. 43 are mechanical angle along the circumference, with one cycle from the left end to the right end being 360°.

Stator poles 25, 26 and 27 of the individual phases shown in FIG. 43 may be circumferentially skewed to reduce torque ripple.

When the stator pole configuration shown in FIG. 43 is used, realization of an air-gap surface configuration of the stator pole requires shaping the poles between the windings 15, 16, 17 and 18 of the individual phases and the air-gap portion. To this end, the end of each of the stator poles of the individual phases is required to have a shape coming out in the rotor shaft direction. This entails a need of a space for the end of each of the stator poles to axially come out. Thus, a problem arises that the outer shape of the motor tends to become large in order to ensure the space.

FIG. 44 is a circumferential development illustrating another modification of the stator poles, i.e. a modification of the stator pole shapes for mitigating the problem. FIG. 44 shows an example, in which, the shapes of the stator poles 28, 29 and 30 of the individual phases have been modified so that a phase difference of 120° in electrical angle is maintained, while the configurations and amplitudes of the unit voltages Eu, Ev and Ew of the individual phases are substantially the same, on condition that: the U-phase unit voltage corresponding to a rotation angle rate of the magnetic flux φu that resides in the U-phase stator pole 28 is Eu (=dφu/dθ); the V-phase unit voltage corresponding to a rotation angle rate of the magnetic flux φv that resides in the V-phase stator pole 29 is Ev (=dφv/dθ); and the W-phase unit voltage corresponding to a rotation angle rate of the magnetic flux φw that resides in the W-phase stator pole 30 is Ew (=dφw/dθ) in the stator 14. The shapes of these stator poles are characterized in that the length of each of the air-gap surfaces of the stator poles 28, 29 and 30 is mostly small for intermediate portions of individual teeth, i.e. the individual stator poles, so that the magnetic fluxes from the rotor 11 can easily pass the stator pole surfaces and the intermediate portions of the teeth and can further pass through magnetic paths toward the back yoke of the stator 14. Accordingly, comparing with the stator pole shapes shown in FIG. 43, the stator pole shapes shown in FIG. 44 can reduce the spaces between the phase windings 15, 16, 17 and 18, and the air-gap portions. As a result, the outer shape of the brushless motor can be reduced.

FIG. 45 is a circumferential development illustrating another modification of the stator poles, in which the stator pole shapes shown in FIG. 43 are further modified. In the example shown in FIG. 45, the U- and W-phase stator poles 34 and 36, respectively, at the axial ends of the rotor shaft 11 are circumferentially expanded in the pole width by 180° in electrical angle. The remaining space is distributed and located so as to balance the V-phase stator poles 35. As to the portions of the teeth of the U- and W-phase stator poles 34 and 36, respectively, whose surfaces are located far from the back yoke, end portions thereof are removed because these end portions are so thin that they are difficult to be fabricated. Indicated by numeral 35 are the V-phase stator poles. The rotation angle rates, i.e. the unit voltages Eu, Ev and Ew, at the surfaces of the stator poles of the individual phases having such shapes are modified so as to have the same value, although the phases are different. As a result, the shapes of these stator poles can allow for passage of comparatively large effective magnetic fluxes and can be comparatively easily fabricated.

As shown in the examples of FIGS. 37, 43, 44 and 45, the stator poles opposed to the rotor may have various configurations depending on the purposes, such as increase of torque, reduction of torque ripple or facilitation of fabrication.

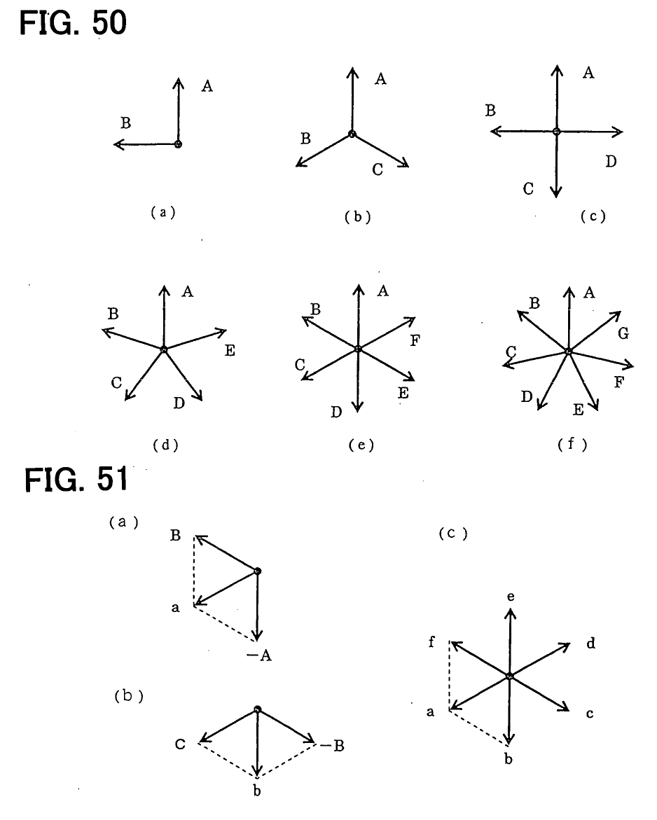

FIG. 50 illustrates vectorial relationships of two- to seven-phase alternating currents. Each of the motors shown in FIGS. 34 to 45 is passed with the three-phase alternating current shown by (b) of FIG. 50. In particular, in a motor having a structure to which the loop windings shown in FIG. 40 are applied, magnetic paths including the stator poles are passed with three-phase alternating current. Specifically, it is regarded that two windings are used in three phases, and that, for the current of the remaining one phase, the two windings are serially supplied with current instead of the third winding. Each of the three-phase motors shown in FIGS. 34 to 45 may be implemented, in a similar concept, in the form of a multiphase of four or more.

Each of the motors shown in FIGS. 34 to 45 can be regarded as having a configuration which is an eight-pole version of the motor shown in FIG. 16, with a modification of arranging the stator poles and the windings in the slots in a circumferential direction. The winding obtained by serially and circumferentially connecting the windings B35 and B39 of FIG. 16 corresponds to the winding 38 of FIG. 40, which is the combination of the windings 15 and 16 of FIG. 34. Such loop windings 38 and 39 can eliminate use of the return wires B36 and B3A of FIG. 16. Thus, a small motor can be realized, which not only dispenses with a copper wire material but also reduces copper loss and enhances efficiency. The same applies to other motors, such as the ones shown in FIGS. 24 and 33. Thus, each of the motors can eliminate the return windings D39, E87, E88, and the like.

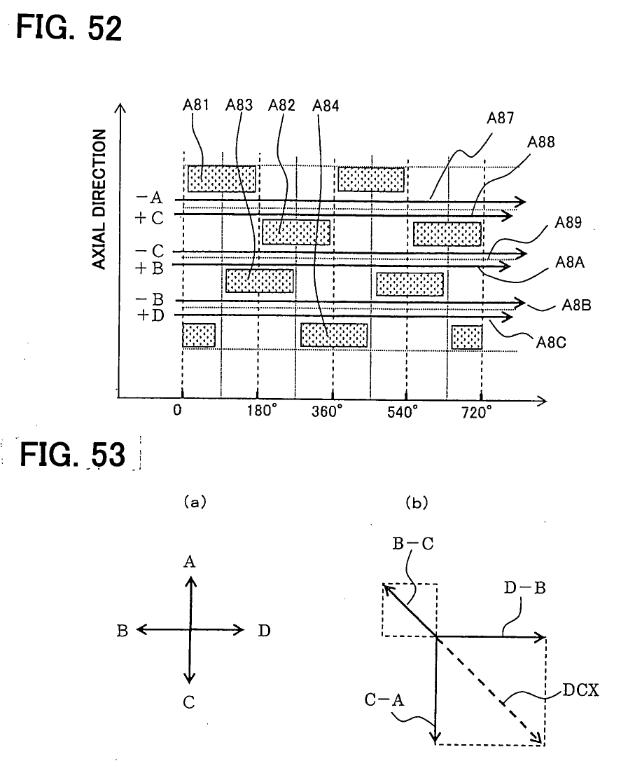

FIGS. 52 and 53 show another example of a four-phase AC motor. FIG. 52 is a development of the surfaces of the stator poles opposed to the rotor. The horizontal axis indicates circumferential angle of the stator in electrical angle up to 720°. The vertical axis indicates the rotor shaft direction. Indicated by A81, A82, A83 and A84 are the stator poles of four phases. The configuration of these stator poles is not simply the four-phase version of the stator pole configuration shown in FIG. 37, but is a configuration in which there is a mutual phase difference of 180° in electrical angle between the stator poles A81 and A82 and between the stator poles A83 and A84. Indicated by A81 are A-phase stator poles, by A82 are C-phase stator poles, by A83 are B-phase stator poles and by A84 are D-phase stator poles. By adjacently arranging the stator poles having a phase difference of 180° in the rotor shaft direction, the stator poles of the individual phases can be readily expanded, in the rotor shaft direction, into the vacant spaces shown in FIG. 52. A winding A87 is supplied with a current corresponding to a vector A shown by (a) of FIG. 53, a winding A88 is supplied with a current corresponding to a vector C, a winding A89 is supplied with a current corresponding to a vector −C, a winding A8A is supplied with a current corresponding to a vector B, a winding A8B is supplied with a current corresponding to a vector −B, and a winding A8C is supplied with a current corresponding to a vector DC.

In this case, the windings A87 and A88 may be combined into a single winding to supply therethrough a current of a vector C-A shown by (b) of FIG. 53. Similarly, the windings A89 and A8A may be combined into a single winding to supply therethrough a current of a vector B-C shown by (b) of FIG. 53. The windings A8B and A8C may be combined into a single winding to supply therethrough a current of a vector D-B shown by (b) of FIG. 53. In this way, copper loss can reduce to about ⅚.

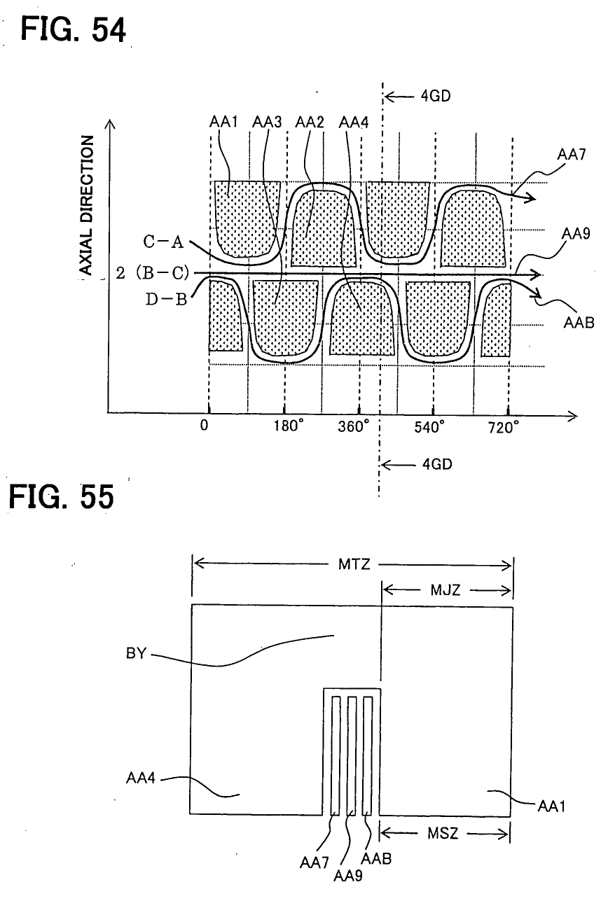

FIG. 54 shows a configuration of the stator poles and windings, which is an improvement of the configuration shown in FIG. 52. Indicated by AA1 are A-phase stator poles, by AA2 are C-phase stator poles, by AA3 are B-phase stator poles and by AA4 are D-phase stator poles. Unlike the stator pole configuration shown in FIG. 52, the stator poles are arranged covering substantially the entire surface opposed to the rotor. Accordingly, magnetic fluxes from the rotor can be efficiently passed to the side of the stator for interlinkage with the windings, whereby generation of large torque can be expected. A winding AA7 is supplied with a current corresponding to the vector C-A shown by (a) of FIG. 53. A winding AA9, whose number of turns is half of that of the winding AA7 and a winding AAB, is supplied with a current corresponding to a vector expressed by 2×(B−C). The winding AAB is supplied with a current corresponding to the vector D-B. With such a configuration, the sum of the three currents of the three windings can be constantly zeroed. Further, star connection of the three windings of the motor shown in FIG. 64 may enable use of a three-phase inverter. As will be described later, a configuration shown in FIG. 92 can be employed to enable driving by four power elements.

The winding AA7 will have a voltage in proportion to a rate of the change of the magnetic fluxes in the A- and C-phases. Also, the winding AAB will have a voltage in proportion to a rate of the change of the magnetic fluxes in the B- and D-phases. The winding AA9, which is supplied with the current expressed by 2×(B−C) so as not to cause interlinkage of fluxes therewith, will principally have no flux interlinkage and thus will basically be applied with no voltage that would be generated at a rate of the temporal change of the magnetic fluxes. Meanwhile, the winding AA9 will be applied with a little voltage corresponding to the voltage reduction of the winding resistance and a little voltage generated at a rate of the temporal change of the leaked magnetic fluxes.

FIG. 55 shows a cross section taken along a line 4GD-4GD of the stator poles shown in FIG. 54. One of the differences of this motor from the motor shown in FIG. 52 resides in the shape of each stator pole in the surface opposed to the rotor. Indicated by BY is a back yoke of the stator, by MTZ is a length of the back yoke in the rotor shaft direction, and by MSZ is a length of a portion of the B-phase stator pole AA1, which faces the rotor. The length MSZ is larger than MTZ/4. Accordingly, the rotation angle rate of the magnetic flux passing through each stator pole AA1 is large, so that large torque can be expected. A thickness MJZ of the magnetic path of the stator pole AA1, which extends from a vicinity of the rotor surface to the back yoke BY is made large as much as possible. The thickness MJZ is allowed to be the same as the length MSZ at the end of the stator pole to provide a structure which is unlikely to cause magnetic saturation.

The windings AA7, AA9 and AAB shown in FIG. 55 are arranged between the B-phase stator pole and the D-phase stator pole so as to extend to an opening portion between the stator poles, which is opposed to the rotor. Thus, a structure, which is unlikely to cause flux leakage between the associated stator pole and a stator pole of other phase, can be provided. This structure has an advantage of generating eddy currents in the wires in the event flux leakage is increased, to thereby prevent increase of the magnetic fluxes. In this structure shown in FIG. 54, the windings are arranged in the similar manner between the individual phases, so that flux leakage from between the associated stator poles and the stator poles of other phases can be reduced as much as possible. Thus, the motor structure shown in FIGS. 54 and 55 is ensured to obtain large peak torque.

However, excessive eddy currents will cause unignorable eddy current loss. Therefore, a degree of flatness of each of the windings AA7, AA9 and AAB is determined based on the relationship between the adverse effect of the flux leakage and the magnitude of the eddy current loss. Each of the four-phase AC motors shown in FIGS. 52 to 55 can be modified to a multiphase motor having five or more phases.

Each of the stator poles of FIG. 54 has a special shape close to a rectangle, but can be modified into various shapes. For example, when electromagnetic steel plates are used for each stator pole by being stacked in the rotor shaft direction, considering the material, or for the convenience of fabrication, the stator pole shown in FIG. 54 may better have a rectangular shape to facilitate fabrication by pressing and punching the electromagnetic steel plates and to facilitate stacking of the electromagnetic steel plates. On the other hand, when each stator pole is fabricated by press-molding a dust core with a mold, the stator pole may have a high degree of freedom in its shape. In this case, the curved shape as shown in FIG. 54 is convenient for press molding.

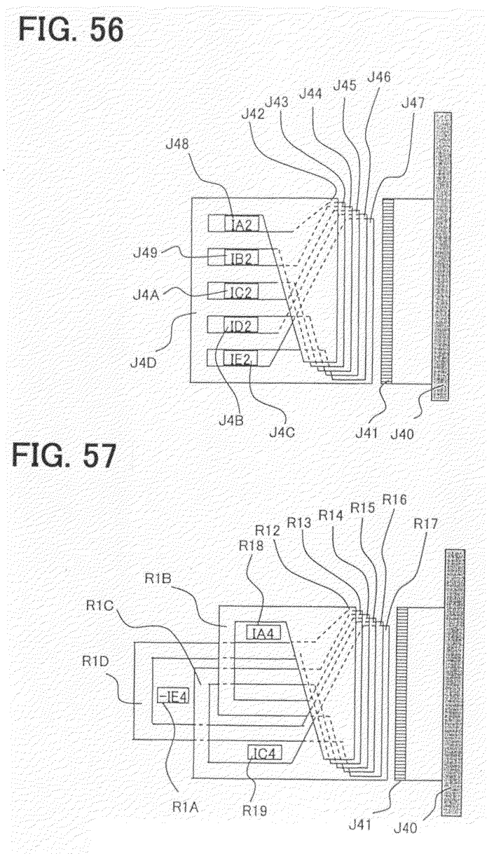

Hereinafter is described a six-phase motor having loop windings. FIG. 56 is a vertical cross section illustrating a six-phase motor. This figure shows only a left side of a rotor J40. Indicated by J41 are permanent magnets for providing a multipole rotor as shown in the development of FIG. 35. Indicated by J42, J43, J44, J45 and J46 are stator poles for six phases. These stator poles are arranged so as to have a phase difference of 60° in electrical angle from each other with respect to the rotor. Indicated by J48, J49, 4A, J4B and J4C are windings for five phases in the six phases. Indicated by 14D is a back yoke of the stator.

The motor shown in FIG. 56 can also be regarded as a six-phase version modification of the three-phase motor shown in FIG. 34. Further, the six-phase motor shown in FIG. 56 can also be regarded as a motor obtained by multipolarizing the motor shown in FIG. 28, in which the arrangement of the stator poles has been changed and the connecting relationship between the windings has been changed to obtain loop windings.

FIG. 57 shows a six-phase motor having a configuration different from the one shown in FIG. 56. Indicated by R12 is an A-phase stator pole which is magnetically linked to a D-phase stator pole R15 through a magnetic path R1B, for interlinkage with a current IA4 of a winding R18. Indicated by R14 is a C-phase stator pole which is magnetically linked to an F-phase stator pole R17 through a magnetic path R1C, for interlinkage with a current IC4 of a winding R19. Indicated by R13 is a B-phase stator pole which is magnetically linked to an E-phase stator pole R16 through a magnetic path R1D, for interlinkage with a current −IE4 of a winding R1A. Since the magnetic path R1D for the B- and E-phases is reversely directed, the current is indicated by a reversed symbol. Comparing with the motor shown in FIG. 56, the magnetic paths of the stator of this motor are separated into three sets, so that the mutual interlinkage of magnetic fluxes can be made small between the magnetic paths of the stator. Thus, this motor is so configured that, by supplying three-phase alternating current to the individual magnetic paths, six-phase magnetomotive force can be applied to the individual stator poles.

The six-phase motor shown in FIG. 57 can be regarded as a multipole version of the motor shown in FIG. 29, with modifications in the arrangement of the stator poles and in the connecting relationship between the windings for obtaining loop windings. The modifications shown in FIG. 57 enable structuring a motor without using return windings, which has been difficult to achieve with the motor shown in FIG. 29.

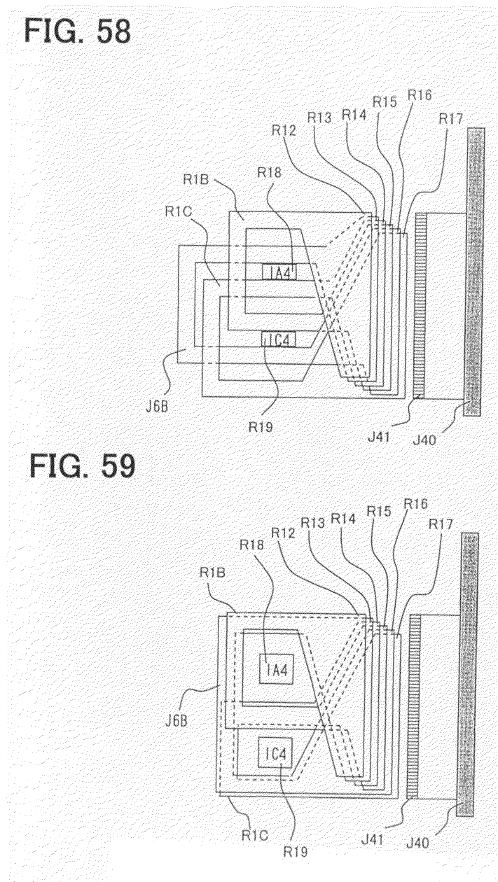

FIG. 58 shows a six-phase motor which is an improvement of the motor shown in FIG. 57. The current −IE4 of the winding R1A interlinking with the winding R1D in FIG. 57 is in a relationship expressed by −IE4=IA4+IC4 as derived from the vectorial relationship shown in FIG. 32. Based on this, in FIG. 58, a magnetic path 36B with a changed route is adapted to make an interlinkage with the windings R18 and R19 rather than the winding R1A.

The six-phase motor shown in FIG. 58 can be regarded as a multipole version of the motor shown in FIG. 33, with modifications in the arrangement of the stator poles and in the connecting relationship between the windings for obtaining loop windings. In case of the motor shown in FIG. 33, the return wires. E87 and E88 have been required for the windings E85 and E86, respectively. The modifications shown in FIG. 57 however can configure a motor without using the return windings. This configuration can achieve a motor having high efficiency and reduced size. FIG. 59 shows a motor having a configuration, in which the arrangement of the magnetic paths of the motor shown in FIG. 58 has been displaced, so that the windings R18 and R19 can be readily imparted with turns and can be readily arranged.

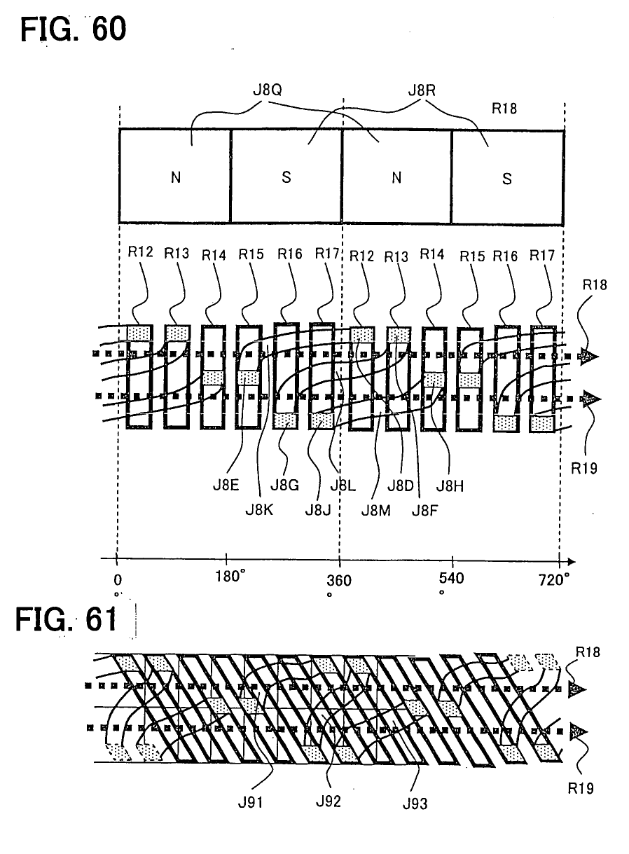

FIG. 60 is a development illustrating a positional relationship and a connecting relationship in the motor shown in FIG. 59. The horizontal axis indicates circumferential direction of the stator in electrical angle, covering a range up to 720° in electrical angle. Indicated by J8Q are N-poles and by J8R are S-poles of permanent magnets of the rotor. Indicated by R12 to R17 are the shapes of the surfaces of the stator poles having phases A to F, which are opposed to the rotor. Indicated by R18 and R19 are windings. Indicated by J8D, J8K and J8E are connecting points and a magnetic path from the A-phase stator pole to the D-phase stator pole. Indicated by R18 and R19 are windings. Indicated by J8H, J8M and J8J are connecting points and a magnetic path from the C-phase stator pole to the F-phase stator pole. Indicated by J8F, J8L and J8G are connecting points and a magnetic path from the B-phase stator pole to the E-phase stator pole.

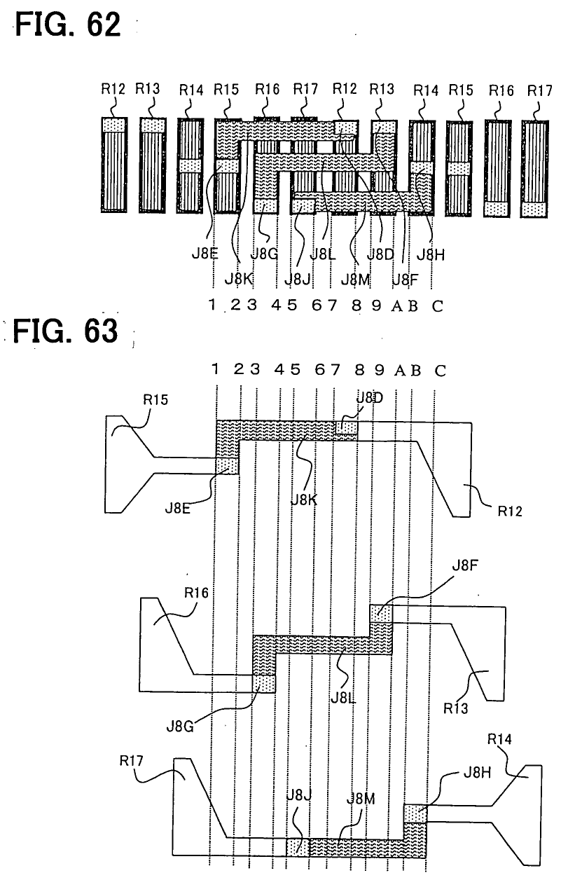

FIG. 61 shows a configuration in which the stator poles shown in FIG. 60 have been circumferentially skewed. FIG. 62 is a development illustrating a detailed configuration of a soft magnetic portion of the motor shown in FIG. 60. Identical portions are indicated by identical symbols. FIG. 63 is an example of a development of electromagnetic plates, illustrating fabrication of soft magnetic portions by bending the electromagnetic plates. Identical portions are indicated by identical symbols. The horizontal axes of FIGS. 62 and 63 indicate a relationship between corresponding portions, by using broken lines and symbols 1 to C.

FIG. 64 shows an example in which electrically conductive plates or closed circuits are arranged at the stator poles shown in FIG. 62 to reduce flux leakage. Indicated by S08 and S09 are the shapes of the stator pole portions, which are opposed to the rotor. Indicated by S07 are the electrically conductive plates or the closed circuits arranged between the stator poles. When flux leakage is increased between the stator poles, voltage is induced by the leaked fluxes to the electrically conductive plates to cause eddy currents, which in turn generate magnetomotive force for reducing the leaked fluxes. Thus, an advantage of reducing flux leakage can be obtained.

FIG. 65 shows an example obtained by modifying the conventional three-phase AC motor with full-pitch or distributed winding shown in FIG. 98 into a two-pole six-slot type motor with full-pitch winding. Indicated by numerals 651 and 652 are coil ends of the U-phase windings which are wound between the slots as shown in the figure. Indicated by numerals 653 and 654 are coil ends of the V-phase windings which are wound between the slots as shown in the figure.

Indicated by numerals 655 and 656 are coil ends of the W-phase windings which are wound between the slots as shown in the figure. As can be seen from the example shown in FIG. 65, coil ends of the windings of the three phases in the conventional motor have overlapped with each other to complicate fabrication of the windings. As a result, the space factor of the windings in the slots has been reduced to raise a problem of large and long coil ends.

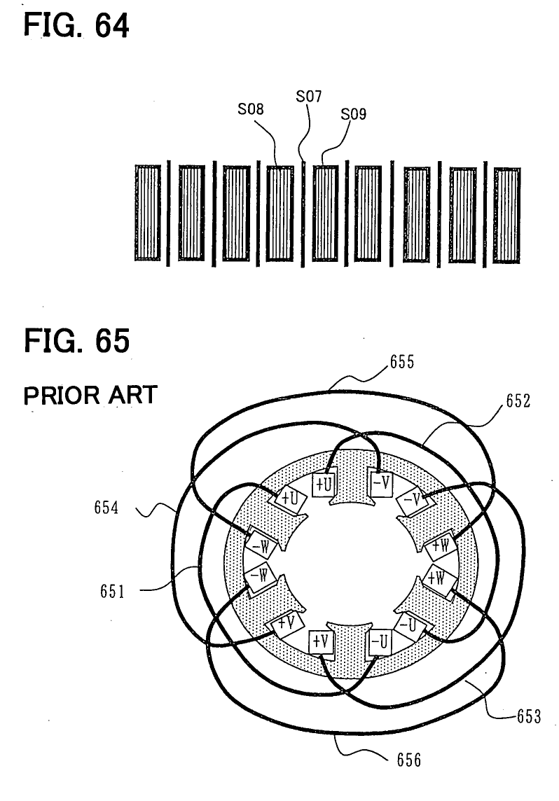

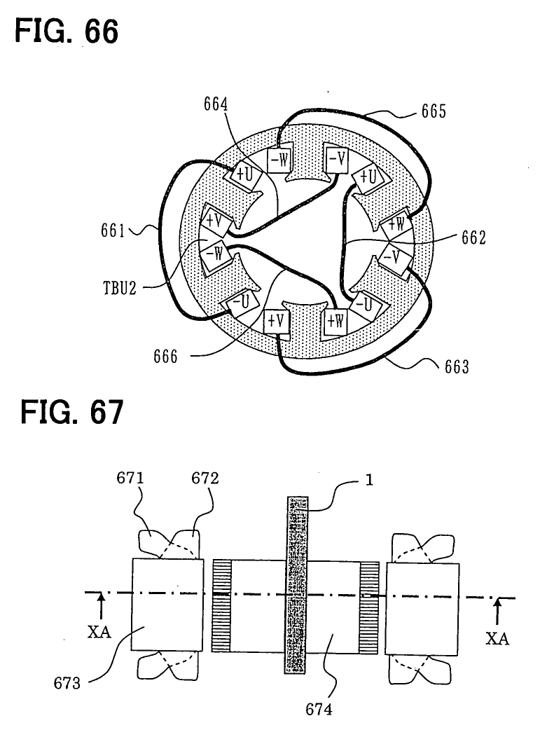

FIG. 66 is a transverse cross section illustrating a connecting relationship of the coil ends of the windings to provide a structure for mitigating the problem of the windings. FIG. 67 is a vertical cross section of the stator. The cross section shown in FIG. 66 has been taken along a line XA-XA of FIG. 67. Indicated by numeral 661 is a connecting relationship at a coil end portion of the U-phase windings. Indicated by numeral 663 is the phase V and by 665 is the phase W. The windings 661, 663 and 665 form a first group of the three-phase windings, in which the individual windings can be wound without crossing with each other. The configuration of the first winding group is indicated by numeral 671 in FIG. 67. As shown, the coil end portion of the first winding group is adapted not to interfere with a coil end portion 672 of a second group of separately wound windings. Indicated by numeral 672 is a connecting relationship at a coil end portion of the U-phase windings. Each of the windings 661, 663 and 665 is imparted with short-pitch winding of 120° to eliminate interference between the three-phase windings.

Indicated by 664 is the phase V and by 666 is the phase W. The windings 662, 664 and 666 form a second group of the three-phase windings, in which the individual windings can be wound without crossing with each other. These six three-phase windings are wound without crossing with each other. Thus, the coil end portions 671 and 672 of the windings can be formed so effectively as to reduce the axial length of the motor. Accordingly, since the windings can be wound easily, the space factor of the windings can be improved.

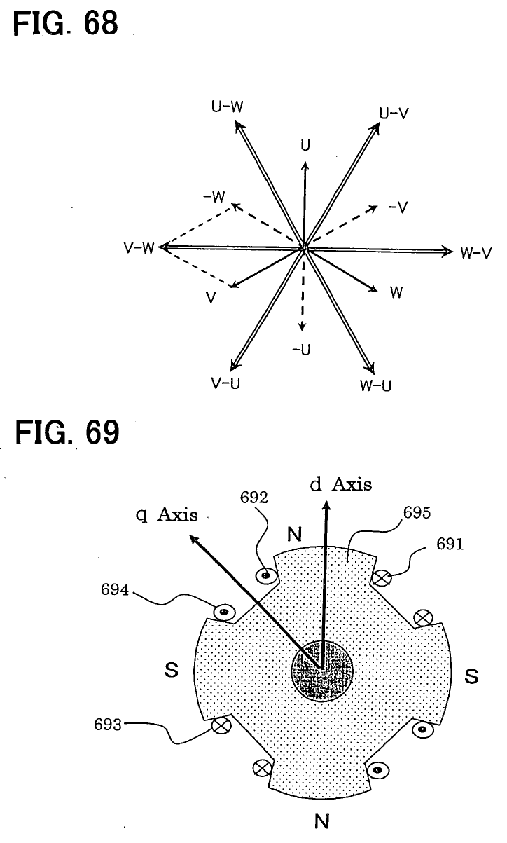

FIG. 68 shows the winding efficiency and winding coefficient of the windings shown in FIGS. 66 and 67. The phases of the windings wound about the slots have a relationship as shown in FIG. 68. Taking as an example the slot about which the windings of the phases V and −W are wound, a sum of the currents will be expressed by a vector V-W as shown in the figure, and, further, the winding coefficient will be 0.866 due to the phase difference of 60° between the two currents. As shown in FIG. 68, sums of the current vectors of the individual slots indicate complete six-phase vectors. Thus, the same advantages as in the case of the full-pitch winding are exerted, except for the winding coefficient. The example of two poles shown in FIG. 66 may be multipolarized, so that the coil end portions can be more effectively shortened in a multipolarized motor having four or more poles.

FIG. 69 shows a rotor having four salient poles with turns of field windings 691, 692, 693, 694 and the like. As shown in FIG. 71 the field windings are connected in series, with a diode being connected in series thereto to form a closed circuit. As a result, the rotor-side field windings are interlinked with magnetic fluxes caused by the stator-side currents to thereby induce voltages and to induce field currents in a discontinuous manner. However, behavior of the rotor-side field currents is complicated and is still discussed today in journals of Institute of Electrical Engineers of Japan, for example. Examples of papers dealing with this technique includes “Analysis of characteristics of half-wave rectification brushless synchronous motor using permanent magnets” Journal D of Institute of Electrical Engineers of Japan, No. 2, Vol. 113-D, 1993, pp., 238-246.

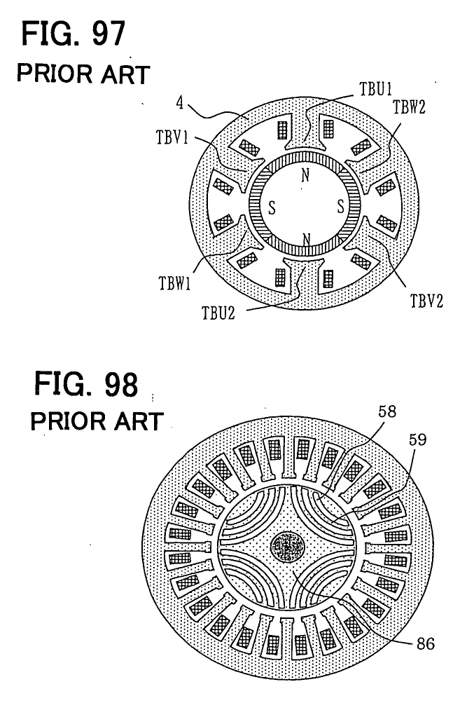

One of the causes for making the behavior of the currents of field windings complicated is considered that, in the characteristics of a motor combining the stator shown in FIG. 98 and the rotor shown in FIG. 69, the q-axis inductance becomes so large as to change the direction of the magnetic fluxes of the rotor depending on conditions. If the q-axis inductance is small, the field magnetic fluxes can be controlled by d-axis currents “id” and the torque can be controlled by q-axis currents “iq”, enabling easy control of the d- and q-axes in an independent manner. Another one of the causes is considered to reside in the discreteness of the magnetomotive force generated by the stator. In the case where there are only three stator poles within an electrical angle of 360° as in the motor shown in FIG. 97, the discreteness becomes so large as to limit the independent control of the d- and q-axes. Thus, effects may not be exerted according to the theory of the three-phase sinusoidal voltages, currents and magnetic fluxes.

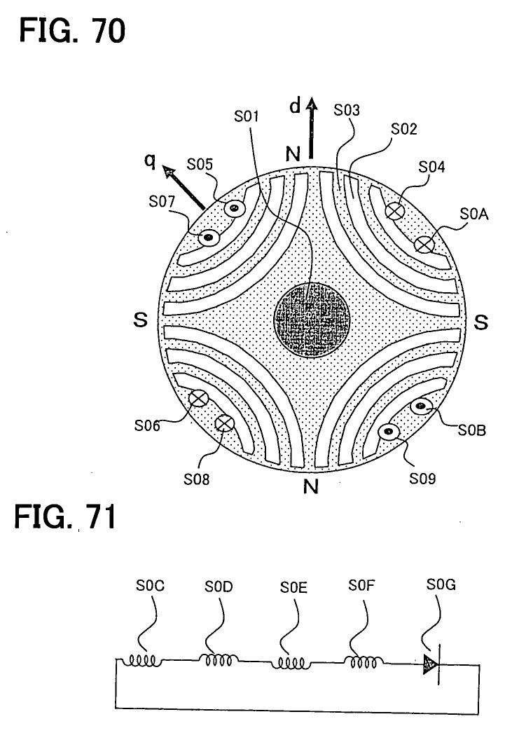

FIG. 70 shows a rotor obtained by additionally providing field windings S06, S07, S08, S09 and the like and a diode S0G shown in FIG. 71, to a so-called multi-flux barrier rotor. Indicated by S01 is a rotor shaft. Indicated by S02 are barriers for preventing magnetic fluxes from passing in the q-axis direction. Each of the barriers has a shape of a slit. For reinforcement of the rotor, for example, these slit-shaped portions may be filled with a nonmagnetic material, such as a resin. Indicated by S03 are narrow magnetic paths each being surrounded by the slit-shaped barriers S02 or the like and having a function of passing the magnetic fluxes toward the portion between the adjacent rotor poles. Indicated by S04 and S05 are windings whose turns are imparted so as to go around the respective rotor poles. The same applies to the windings S06 and S07, S08 and S09, and S0A and S0B. These windings are connected in series as shown in FIG. 71 with the serial insertion of the diode S0G to provide a closed circuit. As a result, field current components which flow when voltage is induced at the field windings of this rotor, work in such a way as to excite the N-poles and S-poles indicated at the rotor poles shown in FIG. 70.

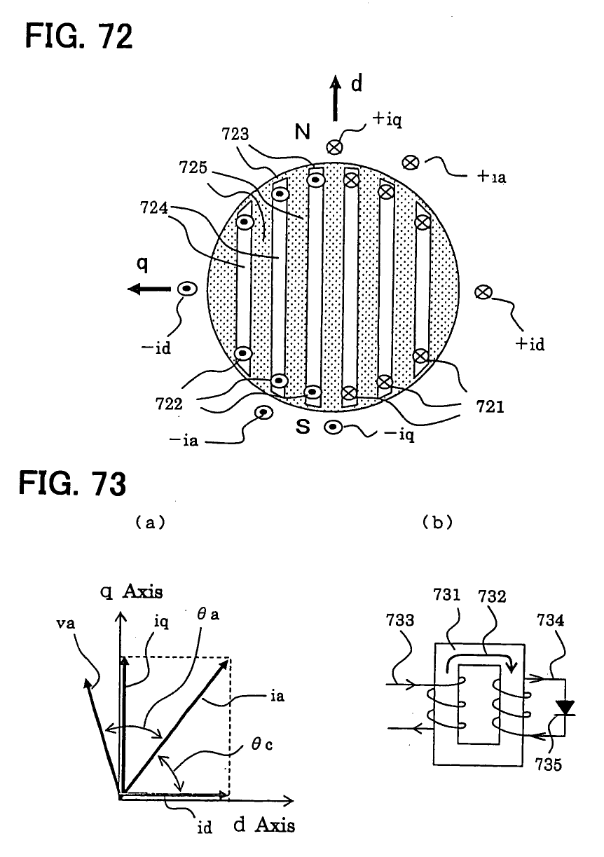

FIG. 72 shows a rotor model obtained by modifying the four-pole rotor structure shown in FIG. 70 to a two-pole rotor. In the figure, this rotor model is expressed on a d-q axis coordinate with additional indication of stator-side winding currents, i.e. d-axis currents +id, −id and q-axis currents +iq, −iq, in conformity with the d- and q-axes. Indicated by numerals 721 and 722 are field windings wound about the rotor, which are serially inserted with a diode as shown in FIG. 71 to constitute a closed circuit. The operation of the rotor shown in FIG. 70 will be described referring to this rotor model.

In the motor model shown in FIG. 72, when a current “ia” is supplied to the stator windings, the current can be taken as consisting of breakeups, i.e. the d-axis currents +id, −id and q-axis currents +iq, −iq shown in the figure. The d-axis currents +id, −id excite the field magnetic fluxes in the d-axis direction through narrow magnetic paths 725 and the like. On the other hand, it is so structured that the q-axis currents +iq, −iq, which are torque currents, generate torque but do not ideally generate magnetic fluxes in the q-axis direction, being prevented by barriers 724 and the like.

In the synchronous reluctance motor model shown in FIG. 72, the magnetic fluxes generated by the q-axis currents +iq, −iq are not zero. Although the value is comparatively small, the motor has an inductance Lq. In the case where the field windings 721 and 722 are not additionally provided, or in the case of the motor shown in FIG. 98, the following formulas can be established. In the following Formulas, Ld is a d-axis inductance, Ψd is the number of interlinked d-axis fluxes, Ψq is the number of interlinked q-axis fluxes, T is torque, vd is d-axis voltage and vq is q-axis voltage.

$$\begin{matrix}Ψ d = Ld \cdot id & ( 1 ) \\ Ψ q = Lq \cdot iq & ( 2 ) \\ T = Pn ( Ld - Lq ) iq \cdot id & ( 3 ) \\ = Pn ( Ψ d \cdot iq - Ψ q \cdot id ) & ( 4 ) \\ vd = Ld \cdot d ( id ) / d t - ω \cdot Lq \cdot iq + id \cdot R & ( 5 ) \\ vq = Lq \cdot d ( iq ) / d t + ω \cdot Ld \cdot id + iq \cdot R & ( 6 )\end{matrix}$$

where Pn is the number of pairs of poles and R is winding resistance.

The vectorial relationship in the motor is shown by (a) of FIG. 73, where θc is a phase of the current “ia” with respect to the d-axis, and θa is a relative phase difference between the current “ia” and voltage “va”. In this case, power factor can be expressed by COS(θa).

In the motor shown in FIG. 98, the power factor COS(θa) of the stator windings is deteriorated and thus the motor efficiency is deteriorated to problematically increase the size of the motor, and accordingly, the inverter capacity is increased to problematically increase the size of the motor control unit. The cost is also increased. There is also a problem that, in terms of the stator structure, the space factor of the windings is reduced and the length of the coil ends becomes large. The motor shown in FIG. 98 is characterized by the low cost ascribed to the nonuse of expensive permanent magnets, the comparatively easy field-weakening control, and the feasibility of constant-power control. Recently, recognition and attention have been paid to the iron loss during loaded and lightly-loaded rotation as an important characteristic in terms of system efficiency. Thus, it is now possible to perform field-weakening control, or to perform control for low iron loss, during lightly-loaded rotation.

A relationship between magnetic field flux φ and current associated with the magnetic field in the configuration shown in FIG. 72 is as follows. That is, when there is a simple relationship that the d-axis inductance Lq is zero, the d-axis currents +id, −id, the magnetic field φ, the field windings 721, 722 and the like of the rotor, and the field currents “if” flowing to the diode S0G are in a relationship represented by a current 733 of a primary winding, magnetic flux 732 of an iron core 731, and a secondary current 734 flowing to a secondary winding in a single-phase transformer shown by (b) of FIG. 73. In the case where such a simplification can be made, the magnetic flux 732 can be comparatively readily controlled. For example, when the magnetic flux 732 is excited starting from zero, flow of the current 733 can excite the magnetic flux 732 which is in step with the current. When zero is established from a state where the current 733 has a value of “io”, voltage is generated in the secondary winding, allowing the secondary current 734 to flow so as to have the value of “io”, to thereby maintain the magnetic flux 732. The secondary current 734 is then decreased in such a way that the energy of the magnetic flux φ is deteriorated by an amount of the loss of the transformer and the diode. As a different example, when a value of io·⅔ is established from a state where the current 733 has a value of “io”, voltage is generated in the secondary winding, allowing the secondary current 734 to flow so as to have a value of io/3, to thereby maintain the magnetic flux 732. In this case, it is so effected that a sum of the primary and secondary currents will be “io”, and current will flow so that the magnetic flux 732 can be maintained at a constant level. The details will be described later, but by driving the rotor having the configuration shown in FIG. 72 utilizing such an effect, the power factor of the stator windings can be improved, efficiency can be enhanced, and current load of the inverter can be reduced. Generally, the d-axis currents subjected to control are often fluctuated by various causes in terms of control. As a result, the magnetic field fluxes are fluctuated to thereby increase torque ripple. When the rotor windings shown in FIG. 70 are arranged, the reduction in the excitation currents of the magnetic fields can be automatically compensated, whereby the magnetic field fluxes are steadied, torque ripple is improved, and the efficiency can also be expected to be improved.

In FIG. 70, the way of giving turns of the field windings of the rotor and the number of turns may be modified or selected depending, for example, on the characteristics of the diode and fabrication properties and strength of the field windings of the rotor. For example, the field windings may be separated into some portions, parallelly wound, or serially or parallelly connected.

In order to achieve a reduced size, high efficiency and low cost in a motor and control unit therefor, and in order to enhance the total product competitiveness of a motor, it is required not only to partially improve the motor, but also to rationalize the configuration of the entire motor system including combinations of parts. As to the rotors shown in FIGS. 71 and 72 as well, characteristics of higher efficiency, smaller size and lower cost can be exerted by combining the rotors with the stators exemplified in the present invention, not with the stator of the motor shown in FIG. 98.

For example, the problems of power factor, efficiency, motor size and cost of the motor shown in FIG. 98 can be solved by combining the three-phase motor having the loop windings as shown in FIG. 34 and a multiphased version thereof, or the six-phase motor as shown in FIG. 59, with the rotor having the configuration shown in FIG. 70. In the case where the stator of the motor shown in FIG. 97 is combined with the rotor having the configuration shown in FIG. 70, current control will be difficult in the rotor-side windings S04 and S05, S06 and S07, S08 and S09, and S0A and S0B. In the case where the stator of the motor shown in FIG. 98 is combined with the rotor having the configuration shown in FIG. 70, power factor and efficiency can be enhanced but the size reduction of the motor will be difficult.

A motor of a small size without having coil ends, and of low cost without having permanent magnets can be realized by combining a stator having loop windings and a relative phase difference of 180° in electrical angle between adjacent stator poles, as represented by the four-phase stators shown in FIGS. 52 to 55, with the rotor having the configuration shown in FIG. 70.

A motor of a small size having short coil ends, and of low cost without having permanent magnets can be realized by combining a stator of short-pitch winding for reducing overlapping of windings for shortening coil ends, and for keeping six-phase current vectors in the slots, as represented by the stators shown in FIGS. 66 and 67, with the rotor having the configuration shown in FIG. 70.

Hereinafter will be described an arrangement of the windings of the rotor shown in FIG. 70. The windings of the rotor shown in FIG. 70 are arranged at boundary portions of the rotor poles, or arranged at portions of the soft magnetic portions. The flux barrier portions in such multi-flux barrier rotors are mostly made up of spaces, which spaces are utilized to arrange the rotor windings as shown in FIGS. 72 and 77. The rotor windings can also be readily and firmly fixed by filling a resin or the like in the flux barrier portions in the vicinities of the winding portions.

Hereinafter will be described an arrangement and distribution of the windings of the rotor shown in FIG. 70. There are a zone in which the magnetic field fluxes are excited by the currents of the stator windings, a zone in which the fluxes are excited by the currents of the rotor-side windings and a zone in which both currents are mixedly present. The stator-side winding arrangement can generate substantially sinusoidal magnetomotive force owing to the conventionally multiphased stator structure. Meanwhile, the windings of the rotor shown in FIG. 70 are arranged at the boundary portions of the rotor poles, or arranged in a concentrated manner. Accordingly, the distribution of the magnetomotive force produced by the currents of the windings of the rotor is not sinusoidal, but rather rectangular. As a result, torque ripple, noise and vibration are likely to be increased. A specific measure to be taken for this is to arrange the windings of the rotor in a distributed manner as shown in FIGS. 72 and 77, whereby magnetomotive force having less harmonic components can be generated. The number of turns of each of the distributed rotor windings can also be selected so that the magnetomotive force generated by the rotor will have a form close to a sinusoidal waveform and less harmonic components. Specific ratio, for example, of the numbers of turns depends on the shape of the rotor and the condition of the winding distribution. The shape of the rotor, the manner of distributing the windings, and the numbers of turns of the distributed windings may be selected so that the distribution of the magnetomotive force will be substantially sinusoidal.

The rotor shown in FIG. 77 will be described. For the rotor shown in FIG. 70, the rotor shown in FIG. 77 is additionally provided with permanent magnets 771. As shown in the figure, polarization N and S of the magnets are directed so as to cancel the magnetomotive force generated by the q-axis currents. Such a configuration can further enhance the power factor of the motor. To avoid overlapping of the advantages with the rotor windings, magnets of low cost, such as ferrite magnets, may be used by a small amount.

The rotor of the motor shown in FIG. 98 has a problem of low strength because a number of slit-shaped spaces are provided as barriers for magnetic fluxes. In terms of high-speed rotation, a measure for reinforcement is needed to be taken so as to endure a centrifugal force. In this regard, the rotor provided with the permanent magnets shown in FIG. 77 has a structure in which the permanent magnets can compensate the flux leakage in the q-axis direction. Therefore, linking portions 772, 773 and the like can be thickened and also linking portions 778 at the peripheral portion of the rotor can be thickened to enhance the rotor strength. This reinforcement is also advantageous from the viewpoint of achieving a rotor structure that can allow the rotor windings to endure the increasing centrifugal force.

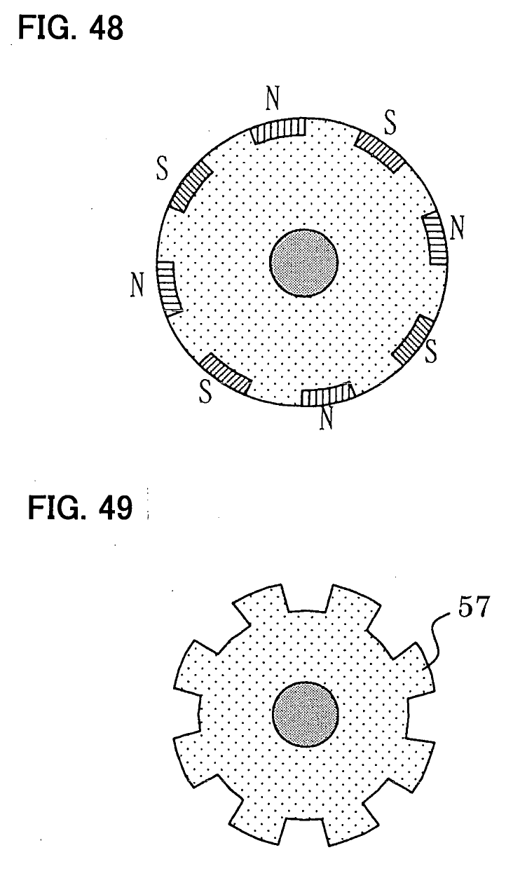

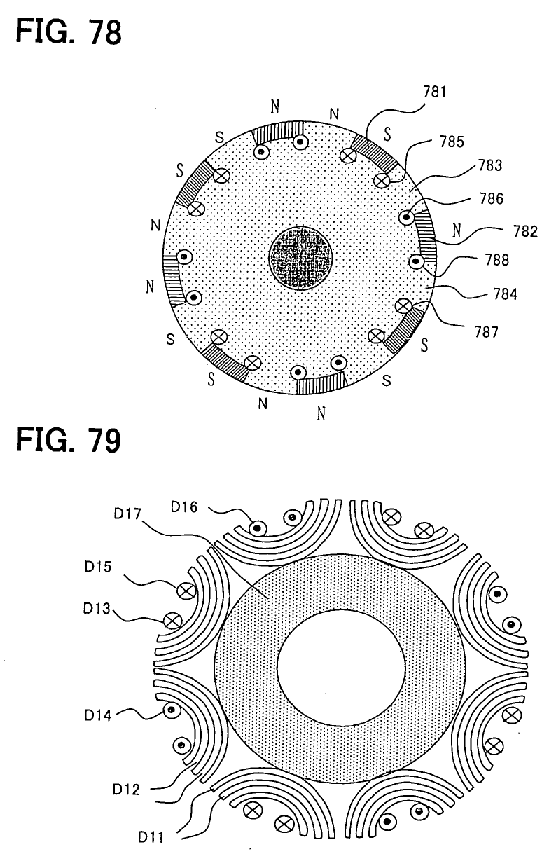

Hereinafter will be described a rotor shown in FIG. 78. This rotor has a structure obtained by additionally arranging windings and a diode, as in the rotor shown in FIGS. 70 and 71, in a so-called inset rotor as shown in FIG. 48. Indicated by numerals 781 and 782 are permanent magnets and by 784 and 785 are soft magnetic portions, with their polarities N and S being as indicated in the figure. Indicated by numerals 785 and 786 are windings imparted with reciprocal turns in the rotor shaft direction. Indicated by numerals 787 and 788 are also the similar windings. This structure may enhance the power factor and steady the magnetic field fluxes at the soft magnetic portions 784 and 785 to thereby enhance the power factor and efficiency and reduce torque ripple. In FIG. 78, the soft magnetic portions arranged along the circumference are all provided with the respective windings. Alternatively, the windings may be arranged along the circumference at every other soft magnetic portion in the rotor surface, in view of the relationship between the magnetic fluxes of the rotor as a whole, and the elimination of the flux leakage to other portions, such as the case.

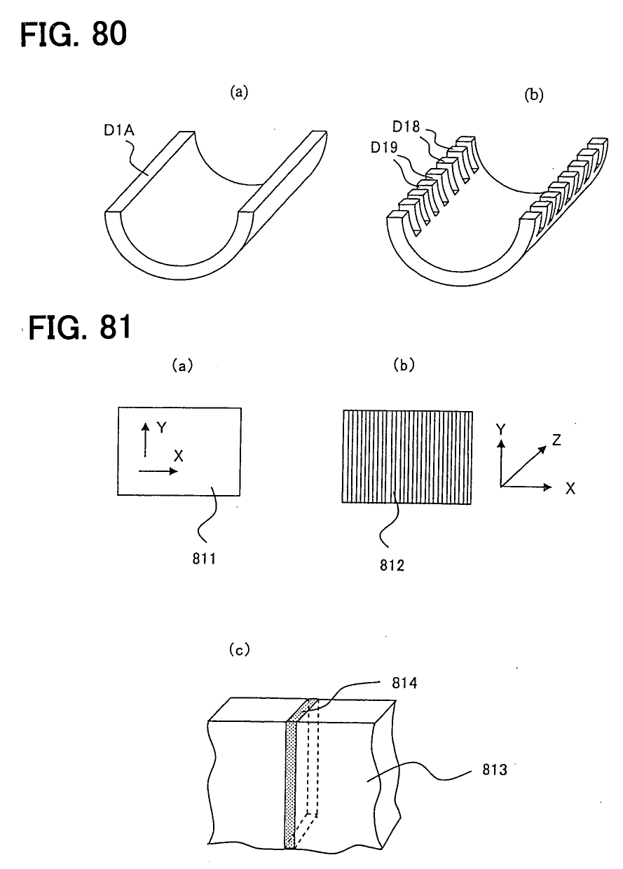

Hereinafter will be described a rotor configuration shown in FIG. 79. The rotor shown in FIG. 70 has a configuration which is obtained by processing the electromagnetic steel plates for the provision of slits therein and by stacking these electromagnetic steel plates in the rotor shaft direction. On the other hand, the rotor shown in FIG. 79 has a configuration which is obtained by radially stacking the electromagnetic steel plates having an arc or trapezoidal shape, for example, as shown by (a) of FIG. 80. Indicated by D11 are electromagnetic steel plates as shown by (a) and (b) of FIG. 80. Indicated by D12 are spaces between the electromagnetic steel plates D11, which spaces may be replaced by a non magnetic material. Indicated by D13, D14, D15 and D16 are windings wound about the rotor poles. As have been shown in FIGS. 70 and 71, these windings are connected in series with a diode to form a closed circuit. Indicated by D17 is a support member of the rotor.

The arrangement of the electromagnetic steel plates as shown in FIG. 79 can increase/decrease the magnetic fluxes in the rotor, in the rotor shaft direction, without making the eddy currents excessively large. Thus, the rotor having such a structure is excellent as a rotor used in combination with a stator having the loop windings, in particular, as shown in FIGS. 34, 52, 54 and 59. This rotor can be used for the increase/decrease of the flux components in the rotor shaft direction without particularly increasing the eddy current loss.

The electromagnetic steel plate shown by (b) of FIG. 80 has soft magnetic portions D18 and cut portions D19 to provide an advantage of reducing eddy currents when the magnetic fluxes increase/decrease at an end portion on front and back sides of the electromagnetic steel plate. Briefly, the portions D19 may only have to serve as electrical insulators, and thus may be very thin electrically insulating films. Such a characteristic can prevent the magnetic fluxes from increasing/decreasing along the circumference and can prevent eddy currents from being generated in the vicinity of the rotor surface, when the rotor shown in FIG. 79, which is opposed to the stator, generates large torque.

Hereinafter will be described a method for controlling currents of the windings which are wound about the rotor shown in FIG. 72, for example. In the above description referring to FIG. 72, it has been explained that, when a simple relationship that the d-axis inductance Lq is zero can be established, the d-axis currents +id, −id, the magnetic field φ, the field windings 721, 722 and the like of the rotor, and the field currents “if” flowing to the diode S0G are in a relationship represented by a current 733 of a primary winding, magnetic flux 732 of an iron core 731, and a secondary current 734 flowing to a secondary winding in a single-phase transformer shown by (b) of FIG. 73.

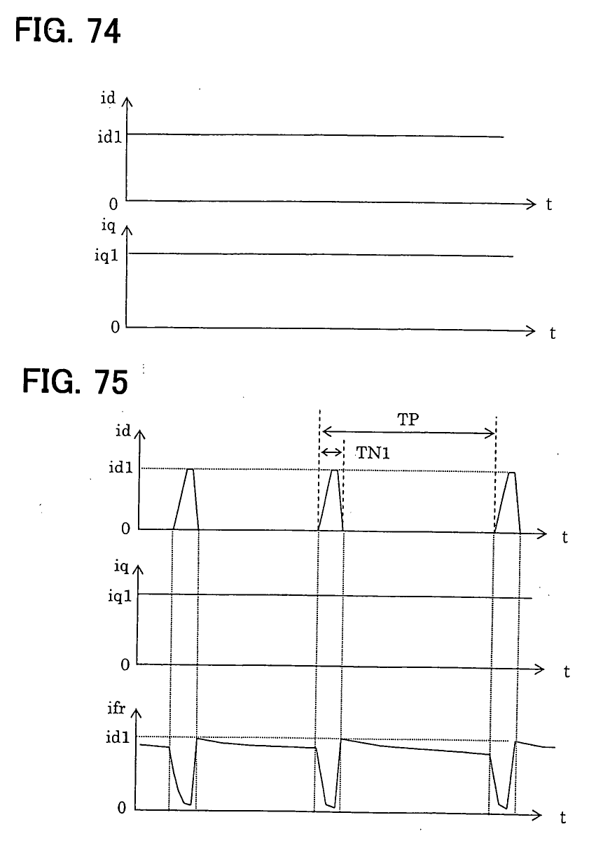

In the case where the windings are not provided to the rotor shown in FIG. 72, when constant torque is to be generated in the rotor, constant currents are supplied by a d-axis current “id1” and a q-axis current “iq1” as shown in FIG. 74. Then, the torque expressed by Formula (3) can be obtained. In the case where the windings 721 and 722 are provided to the rotor shown in FIG. 72, the relationship as indicated in the transformer shown by (b) of FIG. 73 is established. Accordingly, intermittent supply of the d-axis current “id1” during a time zone TN1 at a cycle TP as shown in FIG. 75, can allow a current “ifr”, whose value is approximately the same as “id1”, to flow through the rotor-side windings. Since the total magnetomotive force of the magnetic fields is equal to a sum of the d-axis current “id” and the rotor winding current “ifr”, the magnetic field flux φ can be kept at substantially a constant level. The torque in this case can be obtained through Formulas (3) and (4). Each of the numbers of interlinked fluxes Ψd and Ψq of the d- and q-axes, respectively, is the value obtained as a product sum of the components of the magnetic field flux φ that interlinks with each winding of the stator and the number of turns. In summary, a product of d- and q-axes components φd and φq, respectively, of the magnetic field flux φ and the number of turns, can be used as an approximate value of Ψd and Ψq, respectively. In this way, only an intermittent supply of the d-axis current “id” to the stator windings can effect control in such a way as to obtain steady magnetic field fluxes. Thus, substantially constant torque can be obtained by supplying the q-axis current “iq1” shown in FIG. 75 and the intermittent d-axis current shown in FIG. 75 to the stator windings, thereby enhancing the average power factor of the motor.

In this case, supplying the d-axis current means that the inverter current to be supplied will be the current “ia” which corresponds to a vectorial sum of the q-axis current “iq” and the d-axis current “id”. Thus, the inverter current will be increased. When operation is effected under the condition where the range of the inverter current is sufficiently smaller than a maximum rated current, the load of the inverter is not so much required to be taken into account. However, when a current close to the maximum rated current is supplied to the inverter, an approach of reducing the loading of the d-axis current is desired to be taken. A specific approach may be effecting control so that the q-axis current “iq” will be decreased in the time zone for supplying the d-axis current, and the inverter current “ia” will not also be increased in the time zone for supplying the d-axis current. Although torque may be reduced in the time zones, the average torque reduction in the motor will be very small if the current supply time zone of the d-axis current is short. The reduction can be compensated by increasing the q-axis current “iq” in other time zones.

The current supply time zone TN1 of the d-axis current in FIG. 75, if it is equal to or less than ½ of the current supply cycle TP of the d-axis current, can substantially contribute to enhancing the power factor of the stator currents and to reducing copper loss. As a matter of course, the smaller the ratio is of the current supply time zone TN1 of the d-axis current, the more the average power factor of the stator currents can be enhanced.

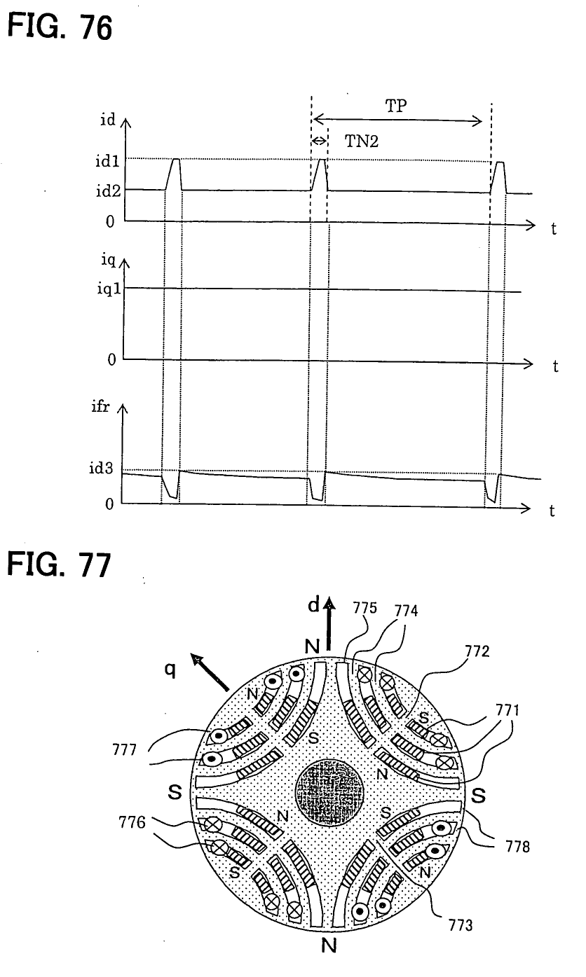

Hereinafter will be described a method for supplying the d-axis current “id” by sharing between the d-axis current of each stator winding and the current “ifr” that flows on the side of the rotor. As can be seen from (a) of FIG. 73, when only a slight amount of d-axis current is supplied to the stator, the increase of the motor current “ia” is very small, and thus the d-axis current causes only a small increase in the copper loss of the stator and only a small increase in the inverter current. As the d-axis current increases, the load of the d-axis current “id” gradually increases. On the other hand, as to the current “ifr” that flows on the side of the rotor, the copper loss is also in step with square of the current. Thus, the excessively large current “ifr” of the rotor is not preferred, from the viewpoint of reducing copper loss of the motor as a whole. For this reason, as shown in FIG. 76, a method that can be taken is to pass the stator-side d-axis current “id” and the rotor-side current “ifr” with an appropriate share. In this method, the d-axis current is supplied up to the predetermined level of the value “id1” during the time zone of supplying the d-axis current, and decreased to the level of the suitable d-axis current “id” during other time zones. In this case, the current “ifr” of the rotor increases, as shown in FIG. 76, during the time zone where the stator-side d-axis current “id” decreases.

When a rotor-side winding resistance is R2, a relationship between the current value, copper loss (ifr)²×R2 and diode loss thereof can be established. Thus, the d-axis current “id” of the stator can be controlled so that a sum of stator-side copper loss (id²+iq²)×R and iron loss will be minimized. This control may enable an operation with maximum efficiency.

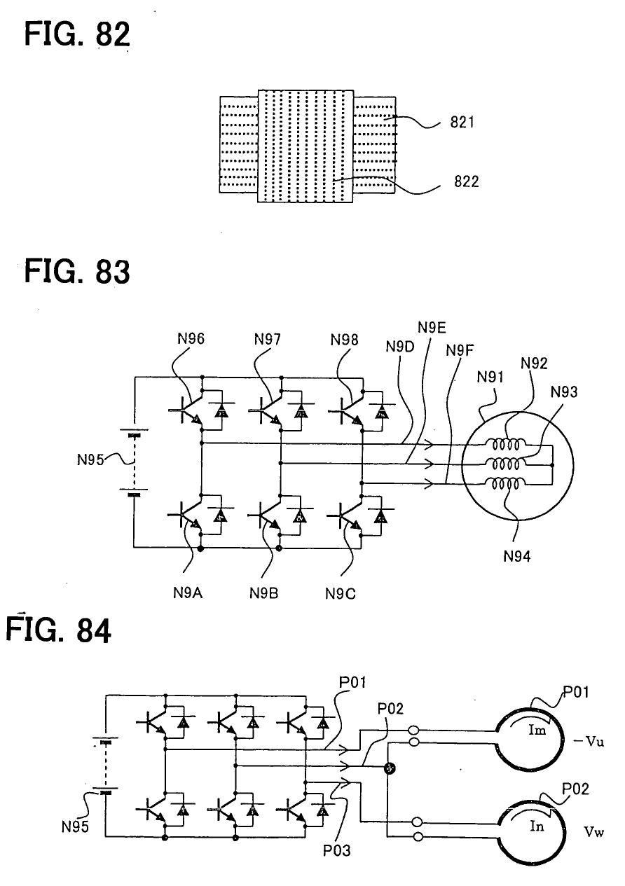

Hereinafter will be described the electromagnetic steel plates, or soft magnetic material, constituting the motor of the present invention shown in FIGS. 81 and 82. Indicated by numeral 811 at (a) of FIG. 81 is a normal non-oriented electromagnetic steel plate. It is fairly common that this non-oriented electromagnetic steel plate can increase/decrease magnetic fluxes in directions X and Y shown in the figure. Although eddy currents increase according to the frequency, frequency ranging from direct current to 400 Hz may be usable within a range that the eddy currents will not become excessively large. The electromagnetic steel plates are employed to serve as the soft magnetic material constituting most of motors.

As indicated by numeral 812 at (b) of FIG. 81, application of the electrically insulating films to the electromagnetic steel plate in the direction Y, can impart the plate with characteristics that the eddy currents will not become excessively large not only in the directions X and Y but also in a direction Z. FIG. 81 shows by (c) an enlarged view of a portion of the electrically insulating film shown by (b) of FIG. 81. Indicated by numeral 813 is a soft magnetic material. The electrically insulating film, in the case where it is made of a nonmagnetic material, is preferred to be as thin as possible because the thinness may readily permit the magnetic fluxes to pass in a direction perpendicular to the film. Thus, the electromagnetic steel plate 812 is adapted not to make eddy currents excessively large for the increase/decrease of the magnetic fluxes in all directions including the directions X, Y and Z. The electromagnetic steel plate 812 applied with such insulating films can be used for the motors having loop windings, as shown in FIGS. 34, 52, 54 and 59, in a particularly advantageous manner because of the presence of the magnetic flux components in the rotor shaft direction.

The insulating films applied to the electromagnetic steel plate 812 shown by (b) of FIG. 81 are generally made of a nonmagnetic material, which raises a problem of deteriorating non-permeability in the direction X. This also raises a problem of deteriorating tensile strength in the direction X. In order to solve these problems, the electromagnetic steel plates shown by (b) of FIG. 81 can be used by putting one on the other so as to crisscross with each other as indicated by numerals 821 and 822 in FIG. 82 and to compensate the defects with each other. This way of putting the electromagnetic steel plates allows for flexibility in the directions of putting the plates, such as vertical, horizontal and oblique directions. In addition, for example, in a direction in which lots of magnetic fluxes are passed, lots of electromagnetic steel plates 812 can be used, with the direction of each of the insulating films being permitted to coincide with the direction in which the fluxes are passed. Thus, the electromagnetic steel plates 812 can be flexibly arranged according the required flux density and strength. Alternatively, for example, the electromagnetic steel plate having the insulating films may be used only for an outer peripheral portion of each motor component, according to the required strength. In this way, a motor with high flux density and high strength can be realized, which is able to three-dimensionally increase/decrease magnetic fluxes.

Dust cores may be used for the motor of the present invention to reduce the eddy currents caused by the increase/decrease of magnetic fluxes in the three-dimensional direction. However, dust cores still leave issues to a certain degree regarding maximum flux density, strength and eddy current loss.

Hereinafter will be described an inverter which is a main circuit portion in the control unit for the motor of the present invention. FIG. 83 shows a conventional three-phase inverter having power control elements indicated by N96, N97, N98, N9A, N9B and N9C, which are so-called IGBTs, power MOSFETs or the like. Each of the power elements is parallelly provided with a diode in a reverse direction. Alternatively, as shown in FIG. 83, parasitic diodes are arranged in a manner of equivalent circuits. Indicated by N95 is a battery, or a DC voltage power source with rectified commercial alternating current, or the like. Indicated by N91 is a three-phase AC motor having windings indicated by N91, N92 and N93 for three phases. The inverter and the motor are connected via wirings N9D, N9E and N9F.

Hereinafter will be described a relationship of the voltages and currents of the windings arranged in the three-phase motor having two windings as shown in FIG. 40, which is based on the motor shown in FIG. 34, and in the six-phase AC motor with two windings shown in FIG. 59, relative to a three-phase inverter. An explanation has been given on the M-phase current Im (=−Iu+Iv) supplied to the winding 38 and the N-phase current In (=−Iv+Iw) supplied to the winding 39 shown in FIG. 40. Connection of these currents to a three-phase inverter is specifically shown in FIG. 84. The windings are applied with voltages −Vu and Vw. Symbols Iu, Iv and Iw here represent three-phase balanced currents, and symbols Vu, Vv and Vw represent three-phase balanced voltages.

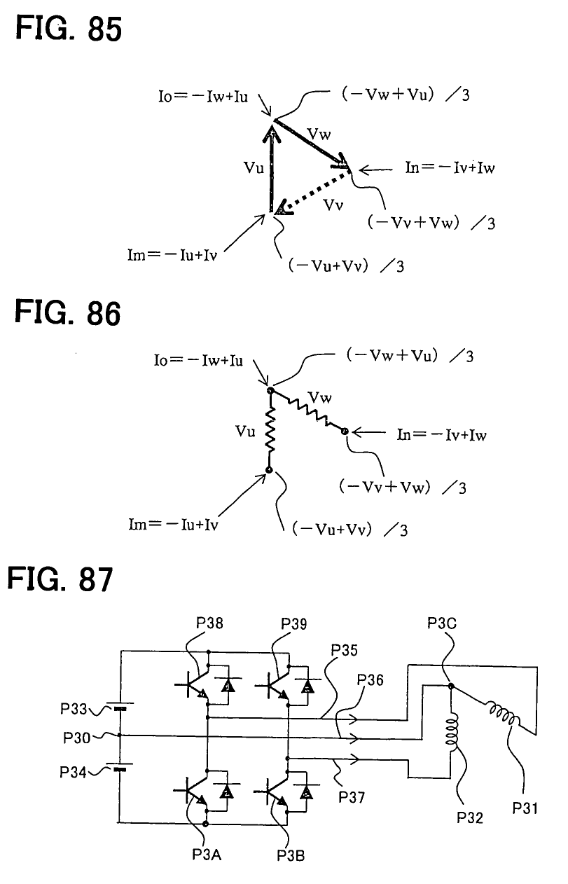

FIG. 85 shows a relationship between voltage vectors and currents of the windings. Voltages of three terminals are also indicated. In the windings shown in FIG. 40, the winding corresponding to a voltage vector Vv indicated by a broken line is absent. A current at a connecting point of these two windings is expressed by Io=−Iw+Iu. In such a configuration, the currents Im, In and Io are also three-phase balanced currents. Accordingly, the load imposed on this three-phase AC motor with two windings, as seen from the three-phase inverter, is balanced between the three-phase voltages and currents. FIG. 86 shows a connecting relationship between the two windings shown in FIG. 84 and a relationship between voltages and currents. Thus, the three-phase AC motor with two windings can be efficiently driven by the three-phase inverter.

The three-phase inverters having a configuration as shown in FIG. 82 have been used without a particular problem. However, if the number of power elements can be reduced, there may be a large number of applications in which cost reduction can be realized. In particular, in the case of inverters used for small motors, the power elements may often have room for capacities of voltages and currents, depending on the circumstances of the peripheral circuitry. In the case of power elements having small capacities, there may be ranges of voltages and currents, in which a little larger voltage or current makes substantially no difference in the cost. Under the circumstances, reducing the number of power elements may sometimes reduce the cost of the device.

FIG. 87 shows a method for driving a three-phase AC motor having two windings using four power control elements. Indicated by P33 and P34 are batteries which are connected in series via a connecting point indicated by P30. Indicated by P38, P39, P3A and P3B are power elements which are connected, forming bridges, to upper and lower voltages of the two batteries P33 and P34. Meanwhile, windings P31 and P32 of the motor are connected to each other through one ends thereof. Indicated by P3C is the connecting point of these windings. In connecting the inverter and the motor windings, the connecting point P30 of the batteries is connected to the connecting point P3C of the motor windings. Then, an output point of a first bridge made up of the power control elements P38 and P3A is connected to the other end of the winding P31. Similarly, an output point of a second bridge made up of the power control elements P39 and P3B is connected to the other end of the winding P32. In this configuration, as in the case shown in FIG. 84, the respective currents are rendered to have relationships expressed by Im=−Iu+Iv, In=−Iv+Iw and Io=−Iw+Iu, so that the motor can be driven. Since the connecting point P3C of the windings P31 and P32 is connected to the connecting point P30 of the power sources P33 and P34, the voltage that can be supplied to the windings is about ½ comparing with the configuration shown in FIG. 84. In a small-capacity motor system, what is important is that the number of parts is reduced. Therefore, driving a three-phase motor with four power control elements will create a significant feature.

Referring to FIG. 90, potentials at each of the parts of FIG. 87 will be explained. Assuming that the potential at the point P30 is zero, the potential at P35 is of the U-phase voltage applied to the winding P31, which corresponds to P61 in FIG. 90. The potential at P37, which corresponds to P64 in FIG. 90, is a −V-phase (minus V-phase) potential. The voltage applied to the winding 32 in this case is the V-phase voltage corresponding to P62.

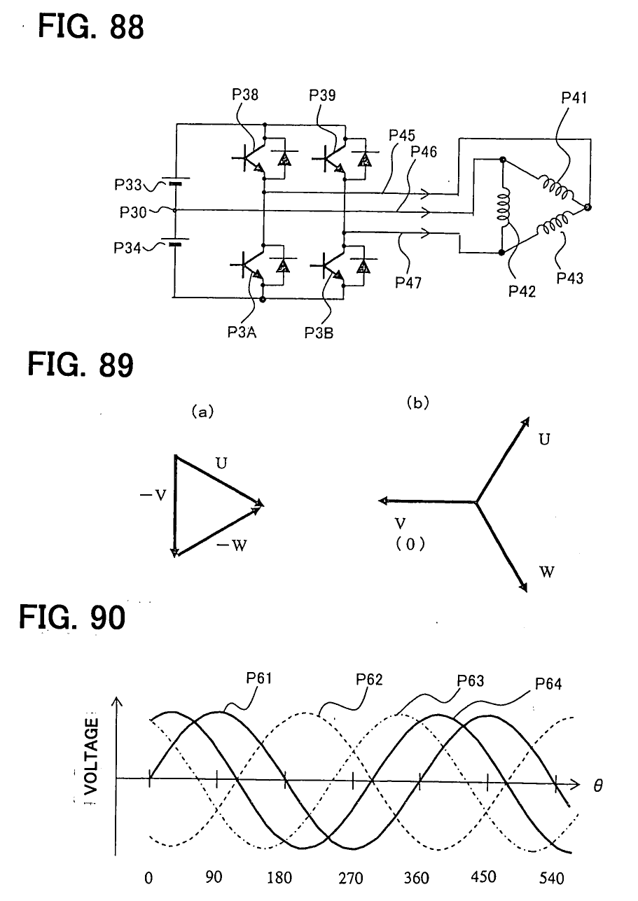

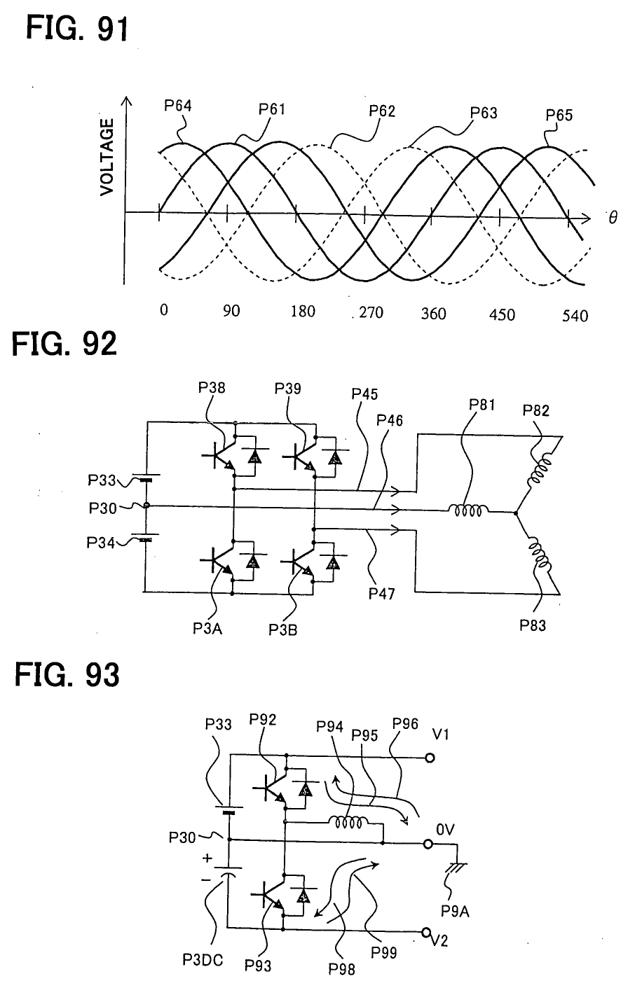

In this condition, the voltage equivalent to the potential difference between P35 and P37 corresponds to P65 in FIG. 91. Accordingly, as shown in FIG. 88, a winding P43 can be additionally provided as one of the three-phase windings. The relationship in terms of voltage vectors is shows by (a) of FIG. 89.

FIG. 92 shows an example of a three-phase motor of star connection, in which voltages and currents are driven by two power sources P33 and P34 and four transistors P38, P39, P3A and P4B. Vector voltages of the individual windings are shown by (b) of FIG. 89. As can be seen, balanced three-phase voltages and currents are supplied to the individual windings. In these three-phase AC motors with three windings, the three-phase motor can also be driven by four power control elements. Thus, advantages in cost and size can particularly be expected in small-capacity motors and control units.

Hereinafter, an explanation will be given on the control unit of the four-phase AC motors shown in FIGS. 52 to 55. The values of the currents of the windings AA7, AA9 and AAB have the relationship as shown by (b) of FIG. 53. When the number of turns of the winding AA9 is ½ of other windings, a sum of the currents of the three windings can be zeroed, and control can be effected with the inverter having the configuration shown in FIG. 92. However, the voltages and currents are different from those of the three-phase motors, as shown by current vectors at (b) of FIG. 53. In this case as well, the four-phase motor can be controlled by four power control elements. Thus, advantages in cost and size can particularly be expected in small-capacity motors and control units.

Costs of the power sources are also important in the application products, such as electric vehicles. The costs for the system associated with a motor include those of a battery portion, converter portion, inverter portion, motor, and mechanism portion required for driving. These portions, as a total, are required to constitute a system having high competitive power. In this sense, a motor configuration is associated with the configurations of batteries and converter.

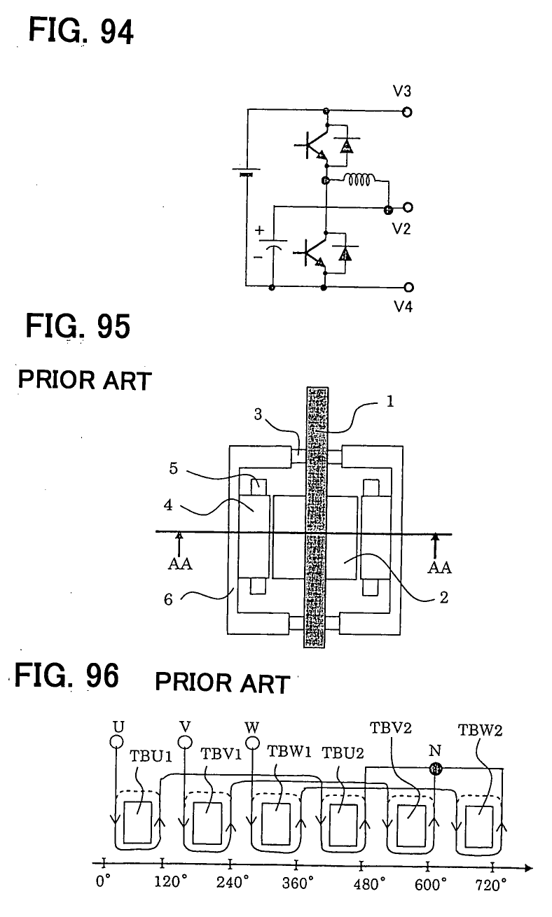

FIG. 93 shows by (a) an example in which one of two power sources is made up of transistors P92 and P93, a choke coil P94 and a capacitor P3DC. The transistors P92 and P93 are capable of charging the capacitor and performing regeneration from the capacitor to the battery, whereby types and amount of battery can be reduced. Voltages V1 and V2 are 42 volts and −42 volts, or 12 volts and −12 volts, respectively, for example. As shown in FIG. 94, a power source from a high-potential side to a low-potential side may be made up of transistors and a choke coil. In this case, relatively high efficiency can be achieved in the converter made up of these two transistors.

An explanation will now be given on a motor and power source voltage in, for example, automobiles, trucks, so-called hybrid vehicles incorporating a motor for driving the vehicle and an engine, and electric vehicles. These vehicles use various types of motors ranging from small motors having a capacity of about 1 W to large motors having a capacity exceeding 100 KW. Also, a variety of power source voltages are used in these vehicles for driving, ranging from about 5 V to about 650 V. A voltage that will give relatively a small harm to humans when touched is considered to be about 42 V. Thus, as to the voltages up to about 42 V, metal portions of a vehicle body, such as chassis, are utilized as grounds, or conductors, for passing currents. In this way, magnitude of power source voltage has an important meaning from the viewpoint of ensuring safety and the viewpoint of cost which owes to utilizing chassis or the like of a vehicle body as conductors, and thus is important in terms of design. However, the range of up to 42 V raises a problem of limiting the capacity of motors.

When the system of FIG. 93 is used with the connecting point P30 being rendered to have a potential of the vehicle body, the battery P33 to have +42V and the battery P3DC to have −42V, safety for humans can be ensured and a relation expressed by 42V+42V=84V can be utilized for the motor power source. This means that tolerable motor capacity can be made larger by a factor of about two than the motor capacity of 42V. The same applies to the configurations shown in FIGS. 88 and 92.

The present invention so far has been described referring to various modes, but various modifications can be made in the present invention, which are also intended to be encompassed in the present invention. For example, as to the number of phases, the description has mostly involved three and six phases, but the present invention may be applicable to two, four, five and seven phases, as well as multiple phases having further number of phases. In small-capacity machinery, the number of parts is desired to be small from the viewpoint of cost and thus small number of phases, i.e. two or three phases, may be advantageous. However, from the viewpoint of torque ripple or from the viewpoint, for example, of the maximum current limitation of a single-phase power device in large-capacity machinery, large number of phases may sometimes be advantageous. The number of magnetic poles may also not be limited. In the motor of the present invention, in particular, large number of magnetic poles may principally advantageous. It is desirable, however, to select an appropriate number of magnetic poles depending on applications and motor sizes, in consideration, for example, of physical limitation, adverse effects such as of flux leakage, increase of iron loss due to multipolarization, and limitation in the control unit due to multipolarization.

Modes of the windings may also be modified, such as distributed winding or short-pitch winding.

The motor of the present invention is structured to generate larger torque as the number of poles is increased. Thus, a motor having a larger number of poles is advantageous unless the motor is disabled by the problems of magnetic saturation, flux leakage and iron loss at portions of the stator core.

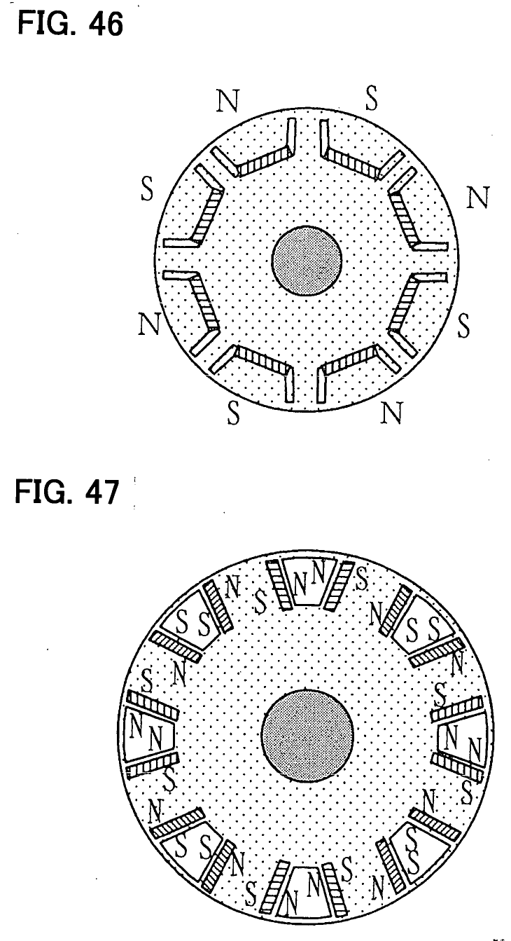

Various types of surface magnet rotors have been described. However, the present invention is applicable to various types of rotors, such as the rotors shown in FIGS. 46 to 49, as well as a winding field rotor in which windings are provided at the rotor, or a so-called claw pole rotor in which field windings fixed at axial ends are provided to produce magnetic fluxes at the rotor through gaps. There is also no limitation in the types and shapes of the permanent magnets.

Various techniques for reducing torque ripple may also be applied to the motor of the present invention. Such techniques include, for example, one for circumferentially smoothing the shapes of the stator and rotor poles, one for radially smoothing the shapes of the stator and rotor poles, and one for circumferentially displacing and arranging some rotor poles to cancel torque ripple components. In the case of a structure which causes unbalance in the magnetic fluxes between the rotor and the stator at the individual phases with the rotation of the rotor, flux-permissible magnetic circuits may be additionally provided between, the back yoke portion of the rotor and the back yoke portion of the stator to have the unbalanced fluxes passed for reduction of cogging torque or torque ripple.

The motor of the present invention may be applicable to various motor modes. For example, the motor of the present invention may be modified into an inner-rotor motor having a cylindrical air gap, when the air gap is expressed by the air-gap shape between the stator and rotor, or an outer-rotor motor, or an axial-gap motor having a disk-like air-gap shape. The inventive motor may also be modified into a linear motor. The inventive motor may also be applicable to a motor shape with a slightly tapered cylindrical air gap. In this case, in particular, the length of the air gap may be varied by axially shifting the stator and the rotor, leading to possible variation of the magnitude of the magnetic fields and possible variation of the voltages. This variable gap may realize constant output control.

A motor may be fabricated by incorporating a plurality of motors including the inventive motor. For example, two motors may be arranged at inner- and outer-diameter sides, or a plurality of motors may be axially arranged in series. Alternatively, the inventive motor may be configured with a portion thereof being omitted and removed. As the soft magnetic members, amorphous electromagnetic steel plates, dust cores obtained by molding powdered soft iron, or the like may be usable other than the normal silicon steel plates. For small motors, in particular, electromagnetic steel plates may be subjected to punching, bending and forging processes to form three-dimensional parts and to obtain a motor partially shaped as described above.

As to the motor windings, the above description mostly involved loop windings. However, the windings may not necessarily have a circular shape, but may more or less be modified so as to have, for example, an elliptical or polygonal shape, or a partially wavy shape in the rotor shaft direction depending on the circumstances of magnetic circuits. Alternatively, where loop windings having a phase difference, for example, of 180° are arranged in the stator, a closed circuit may be formed by connecting semicircular windings to different semicircular windings that have a phase difference of 180°, so that the loop windings can be modified into semicircular windings. The windings may be further divided for modification into arc windings. The description so far has been provided on motors each of which is configured to have loop windings arranged in respective slots. Alternatively, however, a structure with no slot may be provided, where thin windings are arranged near a rotor-side surface, to thereby obtain a so-called coreless motor. As to the currents to be supplied to the motor, the above description has been provided on the assumption that the individual phases have sinusoidal currents. However, control may be performed using currents having various waveforms other than the sinusoidal wave form. These motors with these various modifications are intended to be encompassed in the present invention, as far as the modification technique is based on the spirit of the present invention.

The present application is based on Japanese Patent Application No. 2005-208358 (filed Jul. 19, 2005), the disclosure of which is all incorporated herein by reference.

The invention related to the present application should be defined only by the claims, and thus should not be construed as being limited to the embodiments or the like described in the specification.

1. A motor wherein the motor comprises:
an N-phased motor (N is a positive integer);
rotor poles arranged along a circumference of a rotor;
a stator having phases, with stator poles and magnetic paths thereof being magnetically separated from each other; and
windings of individual phases, which are wound so as to interlink with the magnetic paths of the stator having phases.

2. The motor according to claim 1, wherein:
each of the windings of individual phases is wound so as to interlink with a magnetic path of the associated phase of the winding and a magnetic path of a reverse of the associated phase of the winding.

3. The motor according to claim 1, wherein:
magnetic paths are configured so that magnetic fluxes of the magnetic paths linked to two adjacent stator poles are passed being adjacent to each other; and
the motor is provided with windings which are wound so that the magnetic fluxes of the two adjacent magnetic paths establish unidirectional interlinkage.

4. The motor according to claim 1, wherein the motor comprises:
stator poles of individual phases:
flux-passing magnetic paths SMP, which are linked to the stator poles of individual phases and have a purpose of passing magnetic fluxes to the side of the rotor;
a flux-passing magnetic path RMP for passing magnetic fluxes, which is linked to a back yoke of rotor poles and opposed to the flux-passing magnetic paths SMP of the stator, and has a purpose of passing magnetic fluxes to the side of the stator; and
and windings which are wound so as to interlink with magnetic fluxes that pass through two or more stator poles.

5. A multiphase motor having two or more phases, wherein:
magnetic circuits of the stator are electromagnetically separated within a range of 360° in electrical angle.

6. The motor according to claim 5, wherein:
all or part of windings of individual phases are wound so as to go around only the magnetic paths of the associated phases.

7. The motor according to claim 5, wherein:
two sets of motor components are arranged at inner- and outer-diameter sides or in the rotor shaft direction; and
windings of individual phases are wound so as to interlink with magnetic paths of the two sets of motor components.

8. A six-phase motor, wherein:
when individual phases of stator poles are arranged in the order of A, B, C, D, E and F, A- and D-phase stator poles are electromagnetically connected through a magnetic path ADP, being electromagnetically separated from the stator poles of other phases;
C- and F-phase stator poles are electromagnetically connected through a magnetic path CFP, being electromagnetically separated from the stator poles of other phases; and
E- and B-phase stator poles are electromagnetically connected through a magnetic path EBP, being electromagnetically separated from the stator poles of other phases

9. The motor according to claim 8, wherein the motor comprises:
a winding IA4 which is wound so as to interlink with the magnetic paths ADP and EBP; and
a winding IC4 which is wound so as to interlink with the magnetic paths CFP and EBP.

10. A six-phase multipole motor having four or more poles, wherein:
when individual phases of stator poles are arranged in the order of A, B, C, D, E and F, A- and D-phase stator poles are electromagnetically connected through a magnetic path ADPL, being electromagnetically separated from stator poles of other phases;
C- and F-phase stator poles are electromagnetically connected through a magnetic path CFPL, being electromagnetically separated from stator poles of other phases;
E- and B-phase stator poles are electromagnetically connected through a magnetic path EBPL, being electromagnetically separated from stator poles of other phases; and
windings are wound so as to interlink with the magnetic paths ADPL, CFPL and EBPL.

11. A motor according to claim 10, wherein:
a looped winding IA4 arranged along the full circumference of the motor is wound so as to interlink with the magnetic paths ADPL and EBPL; and
a looped winding IC4 arranged along the full circumference of the motor is wound so as to interlink with the magnetic paths CFPL and EBPL.

12. The motor according to claim 1, wherein the motor comprises:
conductors in the form of electrically conductive plates or closed-circuits, each of which is disposed at a portion where a stator pole or a magnetic path on its extended line comes close to a multiphase stator pole or a magnetic path on its extended line.

13. A motor wherein:
the motor comprises:
slots SL1, SL2, SL3, SL4, SL5 and SL6 arranged in the circumferential direction of a stator;
U-phase windings UU1 and UU2;
V-phase windings VV1 and VV2; and
W-phase windings WW1 and WW2 in three-phase windings,
the U-phase winding UU1 is wound between the slots SL1 and SL3;
the V-phase winding VV1 is wound between the slots SL3 and SL5;
the W-phase winding WW1 is wound between the slots SL5 and SL1;
the windings UW1, VV1 and WW1 constitute a first winding group;
the U-phase winding UU2 is wound between the slots SL6 and SL4;
the V-phase winding VV2 is wound between the slots SL4 and SL2;
the W-phase winding WW2 is wound between the slots SL2 and SL6; and
the windings UU2, VV2 and WW2 constitute a second winding group.

14. A motor wherein the motor comprises:
a rotor in which magnetic paths and a nonmagnetic portions are substantially parallelly arranged between adjacent rotor poles, the rotor comprising:
closed field windings of rotor, which are able to induce magnetic field fluxes to the rotor poles; and
a diode which is serially inserted into a portion of the field windings.

15. The motor according to claim 14, wherein the motor comprises:
stator poles of the same phase arranged along a circumference; and
substantially looped stator windings which are arranged between stator poles of individual phases so as to go around the stator in the circumferential direction.

16. The motor according to claim 15, wherein the motor comprises:
a stator in which stator poles have a phase difference of about 180° in electrical angle, from adjacent stator poles of a certain phase.

17. The motor according to claim 14, wherein:
the motor comprises a stator comprising:
slots SL1, SL2, SL3, SL4, SL5 and SL6 arranged in the circumferential direction of the stator;
U-phase windings UU1 and UU2;
V-phase windings VV1 and VV2;
W-phase windings WW1 and WW2 in three-phase windings,
the U-phase winding UU1 is wound between the slots SL1 and SL3;
the V-phase winding VV1 is wound between the slots SL3 and SL5;
the W-phase winding WW1 is wound between the slots SL5 and SL1;
the windings UW1, VV1 and WW1 constitute a first winding group;
the U-phase winding UU2 is wound between the slots SL6 and SL4;
the V-phase winding VV2 is wound between the slots SL4 and SL2;
the W-phase winding WW2 is wound between the slots SL2 and SL6; and
the windings UU2, VV2 and WW2 constitute a second winding group.

18. The motor according to claim 14, wherein:
the field windings are arranged in the nonmagnetic portions of the rotor.

19. The motor according to claim 14, wherein:
the field windings are wound, being distributed to a plurality of the nonmagnetic portions.

20. The motor according to claim 14, wherein:
permanent magnets are arranged in a part or all of spaces in the nonmagnetic portions.

21. A motor wherein the motor comprises a rotor in which:
permanent magnets are arranged in a circumferential direction on a surface or in the vicinity of the surface of the rotor at an electrical angular pitch of 180° so that N-poles are alternated with S-poles;
portions between the permanent magnets in the vicinity of the surface of the rotor are variable magnetic poles made of a soft magnetic material; and
magnetic paths and nonmagnetic portions are substantially parallelly arranged between magnetic poles, the rotor comprising:
closed field windings of rotor, which are able to induce magnetic field fluxes to the variable magnetic poles; and
a diode which is serially inserted into a portion of the field windings.

22. The motor according to claim 14, wherein:
electromagnetic steel plates, i.e. the soft magnetic material, of the rotor are arranged substantially parallel to the rotor shaft and have a magnetic path structure to form magnetic paths in adjacent rotor poles; and
a plurality of the magnetic path structures are provided at the respective rotor poles.

23. The motor according to claim 22, wherein:
the electromagnetic steel plates, i.e. the soft magnetic material, of the rotor are provided with a plurality of cut portions in the vicinity of the surface of the rotor, or a plurality of electrically insulating films.

24. A motor recited in claim 14 and control unit therefor, wherein:
d-axis currents for stator windings of the motor are controlled in a discontinuous manner.

25. The motor and control unit therefor according to claim 24, wherein:
a time ratio that the d-axis currents supplied to the stator windings are the entire d-axis currents, is 50% or less.

26. The motor and control unit therefor according to claim 24, wherein:
in a time zone where the d-axis currents supplied to the stator windings are not the entire d-axis currents, control is effected in such a way that the entire d-axis currents of the motor are shared between the d-axis currents for the stator windings and the d-axis currents for the field windings of the rotor.

27. The motor and control unit therefor according to claim 26, wherein:
in a time zone where the d-axis currents supplied to the stator windings are not the entire d-axis currents, the d-axis currents for the stator windings are controlled so that the total copper loss of the motor becomes minimum, or motor loss becomes minimum.

28. A motor wherein the motor comprises electromagnetic steel plates, each of which is applied with electrically insulating films in a direction perpendicular to a thickness of the electromagnetic steel plate.

29. The motor according to claim 28, wherein:
the electromagnetic steel plates applied with the insulating films are stacked so as to intersect with each other.

30. A control unit for motor wherein:
the control unit comprises:
two DC power sources; and
four power elements,
the two DC power sources are connected in series;
the four power elements are connected across the serially connected DC power sources so as to form bridges;
two windings of a three-phase AC motor, which windings are for two phases among three phases, are connected to each other at one ends thereof, with a connecting point thereof being connected to a connecting point between the two serially connected DC power sources; and
both ends of the two windings are connected to the individual bridges of the four power elements.

31. A control unit for motor wherein:
the control unit comprises:
two DC power sources; and
four power elements,
the two DC power sources are connected in series;
the four power elements are connected across the serially connected DC power sources so as to form bridges;
one end of a three-phase AC motor with star or delta connection is connected to a connecting point between the two serially connected DC power sources; and
other two ends of the three-phase AC motor are connected to individual bridges of the four power elements.

32. A control unit for motor wherein:
the control unit comprises:
a four-phase AC motor in which A-phase stator poles and C-phase stator poles having a relative phase difference of 180° in electrical angle are adjacently arranged with a winding WAC being arranged between both stator poles, B-phase stator poles and D-phase stator poles having a relative phase difference of 180° in electrical angle are adjacently arranged with a winding WBD being arranged between both stator poles, a winding WACBD is arranged between the A- and C-phase stator poles and the B- and D-phase stator poles, and the three windings are star-connected;
two DC power sources; and
four power elements,
the two DC power sources are connected in series;
the four power elements are connected across the serially connected DC power sources so as to form two bridges;
the other ends of the windings WAC and WBD are connected to the two bridges of the power elements, respectively; and
the other end of the winding WACBD is connected to a connecting point between the two serially connected DC power sources.

33. The control unit for motor according to claim 30, wherein:
one of the two power sources is obtained by performing DC-DC conversion from the other power source.
